(19) United States
(12) Patent Application Publication
(10) Pub. No.: US 2016/0004053 A1
(43) Pub. Date: Jan. 7, 2016

(54) Zoom Lens

(71) Applicant: TAMRON CO., LTD., Saitama-shi (JP)

(72) Inventor: Nobuyuki Adachi, Saitama-shi (JP)

(21) Appl. No.: 14/767,446

(22) PCT Filed: Feb. 13, 2014
(86) PCT No.: PCT/JP2014/053315

§ 371 Date: Aug. 12, 2015

(30) Foreign Application Priority Data
Feb. 13, 2013 (JP) 2013-025753

(51) Int. Cl. G02B 15/163; G02B 27/00

(52) U.S. Cl. CPC G02B 15/163; G02B 27/0025

(57) ABSTRACT

A zoom lens of high zoom ratio that has high quality in imaging performance and achieved downsizing and cost reduction at the same time. The zoom lens includes a positive first lens group to a positive fourth lens group achieves a predetermined zoom ratio by moving all lens groups along the optical axis direction backward and forward in magnification change, wherein the first lens group includes the negative lens, the positive lens and the positive lens; the second lens group includes at least two negative lenses and one positive lens; the third lens group includes two positive biconvex lenses and the negative lens in order from the object side and. The following conditional expression (1) and conditional expression (2) are satisfied:

-42≦f123t/f4×Z≦-25 (1)

8.2≦f3/f4×Z≦13.6 (2)

### TECHNICAL FIELD

The present invention relates to a zoom lens, and specifically relates to a zoom lens of high zooming ratio.

### BACKGROUND ART

Recently, a zoom lens of high zooming ratio exceeding ten times attracts attention as an interchangeable lens for a single-lens reflex camera (hereafter referred to as “SLR camera”). For such a zoom lens, not just high quality in imaging performance but also small size and low-price are required. Such demand has become stronger with widespread market of digital SLR cameras inside and outside of the country. Especially, as the shipping of products for the middle class people increases in developing countries, it is difficult to satisfy market demands without zoom lenses competitive in price.

The optical system of a zoom lens includes a plurality of lens groups, and the number of lenses constituting the lens groups are large. So, reduction of a glass material cost is effective to achieve the price reduction in the zoom lens. Specifically, formation of an optical system by using low-cost lenses made of glass materials relatively cheap in cost may be considered. For example, a glass material so-called an old material is known as a low-cost glass material. If such an old material is used, the cost for materials of the optical system is reduced. However, as the refractive index of the old material is low of around 1.7 or less in general, the image distortion may be “under” remarkably in the optical design solution if the old material is mainly used, and the optical design solution performing preferable imaging may hardly be achieved. The size of the optical system should increase to maintain high quality in imaging performance because the enlarged diameter of a lens and an increase in the number of lenses are necessary for correction of the image distortion. That is, as cost reduction of the optical system conflicts with improvement of the imaging performance and/or downsizing of the optical system, i.e. satisfaction of these demands at the same time has been difficult. In addition, the optical design of the zoom lens is made extremely complicated because of a large demand on further downsizing of the zoom lens.

Patent documents 1 to 3 disclose prior art of the zoom lens. The zoom lens disclosed in Patent document 1 includes the first lens group having a positive refracting power, the second lens group having a negative refracting power, the third lens group having a positive refracting power and the fourth lens group having a positive refracting power in order from the object side to the imaging side, and the a plurality of lens group move along the optical axis direction in magnification change. The second lens group acts as a focusing lens, and in focusing, the second lens group moves to adjust a focusing position. In zoom lenses having such an optical system disclosed in Patent document 1, if a negative lens disposed at the most object side among a plurality of lenses constituting the second lens group is the lens 2a and if the refractive index and Abbe number of the material of the lens 2a are n2a and v(nu)2a, the zoom lens satisfies the following conditions.

-0.0125*v(nu)2a+2.175<n2a<-0.011*v(nu)2a+2.21 42.0<v(nu)2a<59.0

The zoom lens disclosed in Patent document 2 includes the first lens group having a positive refracting power, the second lens group having a negative refracting power, the third lens group having a positive refracting power and the fourth lens group having a positive refracting power in order from the object side, wherein lens groups move along the optical axis direction to make the gap between the first lens group and the second lens group wide, the gap between the second lens group and the third lens group narrow and the gap between the third lens group and the fourth lens group changes in magnification change from the wide angle end to the telephoto end. The third lens group includes a front group having a positive refracting power and a rear group having a negative refracting power in order from the object side, and blurring correction against camera shake is performed by moving just the rear group in the direction perpendicular to the optical axis. Further, the zoom lens suggested has a vibration compensation function that satisfies the following conditional expression if the focal length of the zoom lens at the wide angle end is fw and the focal length of the first lens group is f1.

1.5<fl/fw<8.0

The zoom lens disclosed in Patent document 3 includes the first lens group having a positive refracting power, the second lens group having a negative refracting power, the third lens group having a positive refracting power and the fourth lens group having a positive refracting power in order from the object side, and lens group moves along the optical axis direction to make the gap between the first lens group and the second lens group wide, the gap between the second lens group and the third lens group narrow and the gap between the third lens group and the fourth lens group narrow in magnification change from the wide angle end to the telephoto end. The second lens group acts as a focusing lens group, and in focusing, the second lens group moves toward the object side. In such an optical system disclosed in Patent document 3, the zoom lens suggested has a vibration compensation function that satisfies the following conditions if the focal length of the first lens group is f1, the focal length of the second lens group is f2, the focal length of the third lens group is f3 and the focal length in the telephoto end of the entire optical system is ft.

0.35<f1/ft<0.45

0.04<|f2|/ft<0.065

0.15<f3/ft<0.25

### DOCUMENTS CITED

### Patent Documents

### Patent Document 1

Japanese Patent Laid-Open No. 2009-271471

### Patent Document 2

Japanese Patent Laid-Open No. 2008-304952

### Patent Document 3

Japanese Patent Laid-Open No. 2010-44103

### SUMMARY OF THE INVENTION

### Problems to be Solved

The zoom lenses disclosed in Patent documents 1 and 2 intends cost reduction and weight reduction of a focusing mechanism. Specifically, the invention disclosed in Patent document 1 is characterized in employing a resin lens made of a resin material as a lens disposed at the most object side in the second lens group that moves in focusing. The lens disposed at the most object side among a plurality of lenses constituting the second lens group tends to have a larger lens diameter and a greater weight than the other lenses. So, weight reduction of the second lens is achieved and contribute to high-speed AF (Auto Focusing) and low power consumption if the lens is the resin lens. However, if the lens disposed at the most object side among a plurality of lenses constituting the second lens group is the resin lens, a shape of the lens surface should change to make the diameter of the lens large because the refractive index of resin materials is generally lower than glass materials. Since the enlarged diameter of the lens has a tradeoff relation with the diameter reduction of a filter diameter and a lens barrel diameter, it is not preferable for achieving the downsizing of the zoom lens. In addition, Example of Patent document 1 discloses just a zoom lens of low power about four times and not disclose a zoom lens of high zooming ratio exceeding ten times.

The zoom lens disclosed in Patent document 2 achieves high imaging performance while maintaining the zoom ratio of high zooming ratio. However, both a filter diameter and the entire optical length are large, and it does not achieve a downsizing level required in the present invention.

The invention disclosed in Patent document 3 achieves high imaging performance while maintaining the zoom ratio of high zooming ratio, and further achieves small filter diameter and the short entire optical length. However, the number of lenses constituting the optical system is big, and the cost reduction level required in the present invention is not achieved.

So, an object of the present invention is to provide a zoom lens high in zoom ratio not only maintains high quality in imaging performance but also achieves downsizing and cost reduction at the same time.

### Means to Solve the Problem

As a result of the intensive research, the present inventors have achieved the object by employing the lens structure described later.

The zoom lens according to the present invention includes at least the first lens group having a positive refracting power, the second lens group having a negative refracting power, the third lens group having a positive refracting power and the fourth lens group having a positive refracting power in order from an object side as the lens groups constituting an optical system; and predetermined zoom ratio is achieved by moving all lens groups constituting the optical system along an optical axis direction to adjust gaps; characterized in that the first lens group includes a negative lens having a convex surface at the object side, a positive lens and a positive lens having a convex surface at the object side in order from the object side; the second lens group includes at least two negative lenses and one positive lens; the third lens group includes two positive biconvex lenses adjacently disposed, and a negative lens having a concave surface at the object side in order from the object side; and the zoom lens satisfies following conditional expression (1) and conditional expression (2).

-42≦f123t/f4×Z≦-25 (1)

8.2≦f3/f4×Z≦13.6 (2)

where,
f123t: synthetic focal length at telephoto end of the first lens group to the third lens group
f3: focal length of the third lens group
f4: focal length of the fourth lens group
Z: zoom ratio (focal length at telephoto end/focal length at wide angle end).

The zoom lens according to the present invention is preferable that a curvature radius of a surface at the object side of a positive biconvex lens second from the object side in the two positive biconvex lenses adjacently disposed in the third lens group is smaller than a curvature radius of the surface at an imaging side.

The zoom lens according to the present invention is preferable to satisfy the following conditional expression (3).

0.7≦M2/ft×(|βLT/βLw|)≦7.0 (3)

where,
M2: moving distance of the second lens group from wide angle end to telephoto end in magnification change
ft: focal length at telephoto end
β(beta)LW: paraxial imaging magnification at wide angle end of the fourth lens group
β(beta)LT: paraxial imaging magnification at telephoto end of the fourth lens group.

The zoom lens according to the present invention is preferable to satisfy following conditional expression (4).

0.25≦|M2/M1|≦0.4 (4)

where,
M1: moving distance of the first lens group from wide angle end to telephoto end (where movement toward object side is “+”)
M2: moving distance of the second lens group from wide angle end to telephoto end (where movement toward object side is “+”).

The zoom lens according to the present invention is preferable that the lens groups move to make the gap between the first lens group and the second lens group wide, the gap between the second lens group and the third lens group narrow and the gap between the third lens group and the fourth lens group narrow in magnification change from a wide angle end to a telephoto end.

In the zoom lens according to the present invention, the lens groups constituting the optical system may further include the fifth lens group following the fourth lens group in addition to the first lens group to the fourth lens group, and the lens groups may move to make the gap between the first lens group and the second lens group wide, the gap between the second lens group and the third lens group narrow, the gap between the third lens group and the fourth lens group narrow and the gap between the fourth lens group and the fifth lens group wide in magnification change from a wide angle end to a telephoto end.

The zoom lens according to the present invention is preferable that the third lens group includes the lens group 3a having a positive refracting power and the lens group 3b having a negative refracting power and the lens group 3b moves in a direction perpendicular to an optical axis in vibration compensation.

In the zoom lens according to the present invention, the third lens group includes the lens group 3a having a positive refracting power and the lens group 3b having a negative refracting power, and the lens groups may move to make the gap between the first lens group and the second lens group wide, the gap between the second lens group and the lens group 3a narrow, the gap between the lens group 3a and the lens group 3b wide and the gap between the lens group 3b and the fourth lens group narrow in magnification change from a wide angle end to a telephoto end. Of course, the lens group 3b may move in a direction perpendicular to an optical axis in vibration compensation.

In the zoom lens according to the present invention, the lens groups constituting the optical system further include a fixed lens or a fixed lens group at the most imaging side in addition to the first lens group to the fourth lens group.

The zoom lens according to the present invention is preferable that the second lens group moves toward the object side in focusing from infinity to close end of an object distance.

In the zoom lens according to the present invention, it is preferable that the second lens group and/or the fourth lens group include at least one lens made of resin.

### Advantages of the Invention

By employing the lens structure described above, the zoom lens high in zoom ratio not only maintain high quality in imaging performance but also achieves downsizing and cost reduction at the same time.

### BRIEF DESCRIPTION OF DRAWINGS

FIG. 1 is a cross-sectional view exemplifying structure of an optical system of the present invention, and exemplifies the lens structure at infinity focusing at the wide angle end.

FIG. 2 is the aberration diagrams (spherical aberration, astigmatism and distortion aberration; they are the same in FIGS. 3 to 29 excluding FIG. 20) at the wide angle end zooming of the zoom lens in Example 1.

FIG. 3 is the aberration diagrams at the middle focus zooming of the zoom lens in Example 1.

FIG. 4 is the aberration diagrams at the telephoto end zooming of the zoom lens in Example 1.

FIG. 5 is the aberration diagrams at the wide angle end zooming of a zoom lens in Example 2.

FIG. 6 is the aberration diagrams at the middle focus zooming of the zoom lens in Example 2.

FIG. 7 is the aberration diagrams at the telephoto end zooming of the zoom lens in Example 2.

FIG. 8 is the aberration diagrams at the wide angle end zooming of a zoom lens in Example 3.

FIG. 9 is the aberration diagrams at the middle focus zooming of the zoom lens in Example 3.

FIG. 10 is the aberration diagrams at the telephoto end zooming of the zoom lens in Example 3.

FIG. 11 is the aberration diagrams at the wide angle end zooming of a zoom lens in Example 4.

FIG. 12 is the aberration diagrams at the middle focus zooming of the zoom lens in Example 4.

FIG. 13 is the aberration diagrams at the telephoto end zooming of the zoom lens in Example 4.

FIG. 14 is the aberration diagrams at the wide angle end zooming of a zoom lens in Example 5.

FIG. 15 is the aberration diagrams at the middle focus zooming of the zoom lens in Example 5.

FIG. 16 is the aberration diagrams at the telephoto end zooming of the zoom lens in Example 5.

FIG. 17 is the aberration diagrams at the wide angle end zooming of a zoom lens in Example 6.

FIG. 18 is the aberration diagrams at the middle focus zooming of the zoom lens in Example 6.

FIG. 19 is the aberration diagrams at the telephoto end zooming of the zoom lens in Example 6.

FIG. 20 is a cross-sectional view showing the lens structure at infinity focusing at the wide angle end of a zoom lens in Example 7.

FIG. 21 is the aberration diagrams at the wide angle end zooming of the zoom lens in Example 7.

FIG. 22 is the aberration diagrams at the middle focus zooming of the zoom lens in Example 7.

FIG. 23 is the aberration diagrams at the telephoto end zooming of the zoom lens in Example 7.

FIG. 24 is the aberration diagrams at the wide angle end zooming of a zoom lens in Example 8.

FIG. 25 is the aberration diagrams at the middle focus zooming of the zoom lens in Example 8.

FIG. 26 is the aberration diagrams at the telephoto end zooming of the zoom lens in Example 8.

FIG. 27 is the aberration diagrams at the wide angle end zooming of a zoom lens in Example 9.

FIG. 28 is the aberration diagrams at the middle focus zooming of the zoom lens in Example 9.

FIG. 29 is the aberration diagrams at the telephoto end zooming of the zoom lens in Example 9.

FIG. 30 is a table that shows the numerical value of conditional expressions in Examples 1 to 9.

### PREFERRED EMBODIMENT OF THE INVENTION

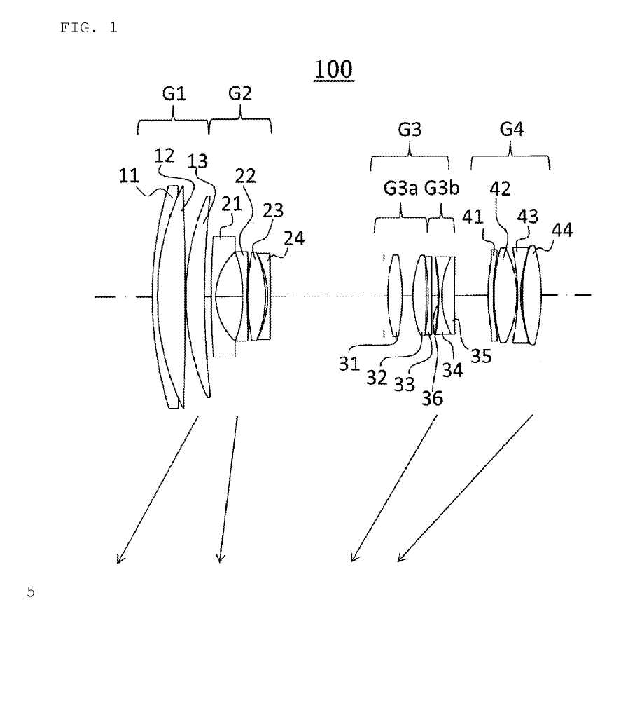

Embodiments of the zoom lens according to the present invention will be described. FIG. 1 exemplifies the structure of the optical system 100 of the zoom lens according to the present invention. FIG. 1 shows the zoom lens including the first lens group G1 having a positive refracting power, the second lens group G2 having a negative refracting power, the third lens group G3 having a positive refracting power and the fourth lens group G4 having a positive refracting power as the lens groups constituting the optical system 100 in order from the object side, where a predetermined zoom ratio is achieved by moving all lens groups constituting the optical system along an optical axis direction to adjust gaps.

### 1. Example of Optical System in Zoom Lens

The lens structure of lens groups constituting the optical system 100 will be described with reference to FIG. 1. Note that the optical system in the zoom lens according to the present invention is not limited to the optical system 100 shown in FIG. 1, and the number of lens groups and the specific lens structure are not specifically limited as long as it includes the first lens group G1 to the fourth lens group G4 as well as it satisfies various conditional expressions such as conditional expression (1) and conditional expression (2) described later. For example, the optical system in the zoom lens according to the present invention may have the structure including other lens groups such as the fifth lens group and the sixth lens group following the fourth lens group G4 in addition to the first lens group G1 to the fourth lens group G4. Further, a fixed lens or a fixed lens group may be disposed at the most imaging side among the lens groups constituting the optical system as described later. Furthermore, arbitrary changes may be made without departing from the scope of the present invention.

The first lens group G1 will be described. In the present invention, the first lens group G1 should just have a positive refracting power as a whole, and the specific lens structure is not particularly limited. For example, the first lens group G1 may be constituted by three lenses of the negative lens 11 having a convex surface at the object side, the positive lens 12 and the positive lens 13 having a convex surface at the object side in order from the object side as shown in FIG. 1. Note that, the negative lens 11 and the positive lens 12 may be a cemented lens as shown in FIG. 1. Further, a positive lens may be further disposed at the most imaging side in addition to these three lenses. Of course, the number of lenses constituting the first lens group should be the minimum number of lenses necessary to achieve optical performance from the viewpoint of achieving downsizing and cost reduction of the zoom lens. The matter is the same in other lens groups.

The second lens group G2 should just include at least two negative lenses 21 and 22 and one positive lens 23 and have a negative refracting power as a whole, and the specific lens structure is not particularly limited. For example as shown in FIG. 1, the second lens group G2 may be constituted by the negative meniscus lens 21 that is disposed at the most object side and has a convex surface at the object side, the negative lens 22 that is disposed next to the negative meniscus lens 21, the positive lens 23 that has a convex surface on both sides and the negative lens 24 that is disposed at the most imaging side and has a concave surface at the object side. Further, various positive lenses such as a positive lens that has a convex surface on the imaging side may be disposed between the negative meniscus lens 21 and the negative lens 22 shown in FIG. 1. In the optical system 100 exemplified in FIG. 1, the second lens group G2 acts as a focusing lens and performs focusing from infinity to the close end of the object distance by moving the second lens group G2 toward the object side in focusing.

The second lens group G2 is preferable to include a lens made of resin from the viewpoint of cost reduction and weight reduction of the optical system 100. The negative lens 22 disposed next to the negative meniscus lens 21 is especially preferable to be a lens made of resin from the viewpoint to make the zoom lens excellent in imaging performance and small in size.

The third lens group G3 includes two positive biconvex lenses 31 and 32 that are adjacently disposed, and the negative lens 33 that has a concave surface at the object side in order from the object side. In Example shown in FIG. 1, the negative lens 33 has a concave surface at the object side. Regarding the positive biconvex lens 32 disposed second from the object side, the curvature radius of the surface at the object side is more preferable to be smaller than the curvature radius of the surface at the imaging side. The third lens group is especially a lens group that exhibits relatively-strong positive refracting power at the wide angle end, and has a role to correct an over-spherical aberration generates in the second lens group toward under. The curvature radius of the surface at the object side of the positive lens 32 smaller than the curvature radius at the imaging side surface may prevent excess correction toward under. If the positive lens 32 further decreases the curvature radius of the surface at the object side to provide a wide air space between the positive lens 31 disposed at the most object side and the negative meniscus lens 33, and the refracting power of an air lens between the positive lens 32 and the positive lens 31 is made appropriate, the spherical aberration may be further corrected and imaging performance at not only the wide angle end but also the entire zooming range may be improved. Further, the lens group 3a may be disposed another positive lens between the positive biconvex lens 31 disposed at the most object side and the positive biconvex lens 32. The specific structure of the lens group 3a may be arbitrarily arranged depending on the structure of the lens group 3b and the other lens groups.

For example as shown in FIG. 1, the third lens group G3 may have a structure including the lens group 3a (G3a) that has a positive refracting power and the lens group 3b (G3b) that follows the lens group 3a and has a negative refracting power, and the lens group 3b may move in the direction perpendicular to the optical axis in vibration compensation. Note that, the lens group 3a may be constituted by at least three lenses 31, 32 and 33.

If the lens group 3b has a negative refracting power as a whole as shown in FIG. 1, the specific lens structure is not particularly limited. For example as shown in FIG. 1, the lens group 3b may be constituted by a cemented lens in which the negative lens 34 having a concave surface at both sides and a positive meniscus lens 35 having a convex surface at the object side are cemented. Further, the object side surface of the cemented lens, i.e. the concave surface at the object side of the negative lens 34 is preferable to be provided an aspherical surface layer 36 made of a plastic material. In the zoom lens, the lens group 3b acts as a vibration compensation lens group and moves in the direction perpendicular to the optical axis in vibration compensation. So, a drive mechanism for moving the lens group 3b in the direction perpendicular to the optical axis is equipped in a lens barrel. If the lens group 3a has such structure, the lens group 3b may be constituted by the lenses having a small diameter because the height of the Fno light beam emitting from the lens group 3a (a light beam contacting to the stop among light beam concentrate on the optical axis) reduces especially at the telephoto end. So, even if the drive mechanism that moves the lens group 3b in the direction perpendicular to the optical axis is equipped in the lens barrel, the enlargement of diameter in the lens barrel is prevented. Further, application of the cemented lens improves the assembly accuracy of the lens group 3b as compared with a case where lenses separates. Further, weight reduction of the vibration compensation lens group (3b) is achieved because the round edge of the positive meniscus lens 35 is thinner in the cemented lens. So, a load on the vibration compensation actuator that moves the vibration compensation lens group (3b) reduces and provides excellent stop operation on the vibration compensation lens group (3b).

The fourth lens group G4 will be described. In the present invention, the fourth lens group G4 should just have a positive refracting power as a whole and the specific lens structure is not particularly limited. However, disposition of at least two positive lenses and one negative lens are preferable and disposition of an aspherical lens of weak refracting power at the most object side of the fourth lens group G4 in addition to these lenses is more preferable, for example. For example as shown in FIG. 1, the fourth lens group may be constituted by a positive meniscus lens 41 that is an aspherical lens, the positive lens 42 having a convex surface on both sides, the negative lens 43 having a concave lens on both sides and the positive lens 44 having a convex surface on both sides in order from the object side. The positive meniscus lens 41 disposed at the most object side is preferable that each surface at the object side and the imaging side is an aspherical surface. As the aspherical lens enables excellent correction of a distortion aberration with a small number of lenses, the aspherical lens is preferable to achieve the downsizing of the zoom lens. Note that, the aspherical lens is preferable to be made of resin. Employment of the lens made of resin reduce the costs required on an optical system as compared with a lens made of glass materials.

As shown in FIG. 1, if the zoom lens has a so-called four-group structure of a positive group precedence type, the fourth lens group G4 is preferable to be constituted by at least three lenses of the positive lens 42, the negative lens 43 and the positive lens 44 in order from the object side. Disposition of these three lenses in the order reduces the lens diameter of the final lens because of the negative lens 43 disposed between two positive lenses 42 and 44. Note that, three lenses may be disposed in the order of the positive lens, the positive lens and the negative lens in the fourth lens group G4. If three lenses are disposed in the order of positive, positive and negative, the lens diameter of the final lens may be reduced. However, back focus is shortened, incidence angle of the light beam into the imaging surface at the most peripheral image height is made sharp, and securement of the peripheral light quantity is made difficult in this case. Three lenses disposed in the order of the negative lens, the positive lens and the positive lens in the fourth lens group G4 is not preferable because aberration correction is made difficult.

The zoom lens according to the present invention is a zoom lens including at least four lens groups of the first lens group G1 to the fourth lens group G4 as the lens groups constituting the optical system 100 as shown in FIG. 1 and is a positive group precedence type the first lens group G1 has a positive refracting power. The zoom lens of the positive group precedence type enables to achieve high imaging performance in the zoom lens of high zooming ratio. Movement of all of the lens groups constituting the optical system 100 in magnification change efficiently maintain the zoom ratio of high zooming ratio and shorten the entire optical length.

The zoom lens according to the present invention is preferable to move the lens groups in magnification change from the wide angle end to the telephoto end to make the gap between the first lens group G1 and the second lens group G2 wide, the gap between the second lens group G2 and the third lens group G3 narrow and the gap between the third lens group G3 and the fourth lens group G4 narrow. Movement of lens groups in this way achieves a high zoom ratio with a small moving distance. That is, a zoom lens of high zooming ratio exceeding ten times is made small in size and is excellent in various kinds of aberration correction.

If the groups 3a and 3b constituting the third lens group G3 integrally moves in magnification change, the third lens group G3 moves as described above. If the lens group 3a and the lens group 3b move independently in magnification change, lens groups moves to make the gap between the second lens group G2 and the lens group 3a narrow, the gap between the lens group 3a and the lens group 3b changes and the gap between the lens group 3b and the fourth lens group G4 narrow. Further, if the optical system 100 of the zoom lens includes the fifth lens group that moves independently from these lens groups in addition to the first lens group G1 to the fourth lens group G4 shown in FIG. 1, lens groups moves to make the gap between the second lens group G2 and the third lens group G3 narrow, the gap between the third lens group G3 and the fourth lens group G4 narrow and the gap between the fourth lens group G4 and the fifth lens group wide. Although, an example where the third lens group G3 is constituted by the lens group 3a and the lens group 3b has been described in the present embodiment, if these lens groups move independently in magnification change, the lens group 3a may be “the third lens group”, the lens group 3b may be “the fourth lens group” and the fourth lens group G4 may be “the fifth lens group”. Further, if the fifth lens group (G5) following the fourth lens group G4 is disposed, the fifth lens group (G5) may be “the sixth lens group”.

Further, a fixed lens or a fixed lens group may be disposed at the most imaging side of the optical system 100 in addition to the first lens group G1 to the fourth lens group G4 described above among the lens groups constituting the optical system 100 of the zoom lens according to the present invention. For example, a positive or negative fixed lens or fixed lens group of weak refracting power may be disposed. The fixed lens group disposed at the most imaging side of the optical system 100 does not damaged advantage of the zoom lens according to the present invention.

### 2. Conditional Expression (1) to Conditional Expression (4)

The present invention achieves cost reduction, price reduction and downsizing in the zoom lens at the same time while maintaining high quality in imaging performance by employing the optical system 100 and satisfying following conditional expression (1) and conditional expression (2) instead of constituting an optical system with cheap lenses made of glass materials with a low refractive index. Each conditional expression will be described one by one.

### 2-1. Conditional Expression (1) and Conditional Expression (2)

The zoom lens according to the present invention is characterized in satisfying following conditional expression (1) and conditional expression (2).

-42≦f123t/f4×Z≦-25 (1)

8.2≦f3/f4×Z≦13.6 (2)

where,
f123t: synthetic focal length at telephoto end of the first lens group to the third lens group
f3: focal length of the third lens group
f4: focal length of the fourth lens group
Z: zoom ratio (focal length at telephoto end/focal length at wide angle end).

### 2-1-1. Conditional Expression (1)

Conditional expression (1) will be described. Conditional expression (1) specifies the value obtained by multiplying a zoom ratio by the ratio between the synthetic focal length in the telephoto end of the first lens group G1 to the third lens group G3 and the focal length of the fourth lens group G4. If the zoom lens satisfies the conditional expression (1), the focal length of the fourth lens group G4 in the zoom lens of high zooming ratio exceeding ten times is adjusted within an appropriate range. As a result, the height (light beam height) from the optical axis of a light beam that pass through the peripheral of lenses constituting the fourth lens group G4 and reaches the imaging surface is made lower because the gap between the fourth lens group G4 and the imaging surface can be made relatively wide under a mechanical restriction, especially at the wide angle end. The diameter of lenses is determined depending on the light beam height of a luminous flux that passes through lenses. So, satisfaction of conditional expression (1) achieves the reduction of cost of glass material because the diameter of the lenses constituting the fourth lens group G4 decreases and the amount of glass material required for the lenses decreases with reduced lens volume.

If the focal length of the fourth lens group G4 is longer than the upper limit of conditional expression (1), the moving distance of the fourth lens group G4 should increases to maintain a desired zoom ratio. If so, the fourth lens group G4 (final lens group) should be disposed at the most imaging surface side within the mechanical restriction if the relationship between the mechanical restriction and the entire optical length at the wide angle end is considered. At the wide angle end, as narrower the gap between the fourth lens group G4 and the imaging surface, higher the height (light beam height) from the optical axis of a light beam that passes through the most peripheral part of the lenses constituting the fourth lens group G4 and reaches the imaging surface. As a result, the diameter of the lenses constituting the fourth lens group G4 should be wide, the amount of glass material for the lenses increases, and the cost of glass material increase. So, it is not preferable.

The focal length of the fourth lens group G4 shorter than the lower limit of conditional expression (1) is not preferable because the refracting power of the fourth lens group G4 strengthens and the eccentric sensitivity of lenses constituting the fourth lens group G4 is made poor. Note that, the eccentric sensitivity denotes the deterioration ratio of imaging performance by the deviation (eccentricity) of the optical axis of lenses. Although, the eccentric sensitivity may reduce in some degree by optimizing the shape of the lenses constituting the fourth lens group G4 and the disposition of lenses, a desired optical system cannot be achieved unless the refracting power of the fourth lens group G4 is optimized at the same time.

To make the zoom lens smaller in size and maintain higher quality in imaging performance, the value (f123t/f4×Z) is more preferable to be -42≦f123t/f4×Z≦-30 in conditional expression (1), and is still more preferable to be -41≦f123t/f4×Z -32.

### 2-1-2. Conditional Expression (2)

Next, conditional expression (2) will be described. Conditional expression (2) specifies the focal length of the third lens group G3. The first lens group G1 has the largest diameter among the lens groups constituting the optical system. The light beam height of a luminous flux that passes through the first lens group G1 greatly depends on the focal length of the third lens group G3 and followers. If the image viewing angle of a light beam emitted from the third lens group G3 to the object side is wide, the front lens diameter increases. On the other hand, if the image viewing angle of the light beam emitted from the third lens group G3 to the imaging side is narrow, diameter of the front lens decreases. If the value of multiplying the zoom ratio by the ratio between the focal length of the third lens group G3 and the focal length of the fourth lens group G4 is in the range shown by conditional expression (2), the focal length of the third lens group G3 is in an appropriate range, and the image viewing angle of the light beam emitted from the third lens group G3 at the object side is narrow to enable diameter of the front lens decrease. So, the first lens group G1 is constituted by the lenses having a small diameter and reduce cost of glass material.

If the focal length of the third lens group G3 is longer than the upper limit of conditional expression (2), the front lens diameter may decrease but the refracting power of the fourth lens group G4 is weak because the image viewing angle of the light beam emitted from the third lens group G3 to the object side is narrow. Such case is not preferable because the drive mechanism should be large because of increased moving distance of lens groups for maintaining of high zoom ratio exceeding ten times. On the other hand, the value of less than the lower limit of conditional expression (2) and the short focal length of the third lens group G3 is not preferable because the image viewing angle of the light beam emitted from the third lens group G3 to the object side is wide. As a result, cost of glass material increases and the filter diameter enlarges because the front lens diameter should enlarge.

To make the zoom lens smaller in size and maintain higher quality in imaging performance, the value “f3/f4×Z” in the conditional expression (2) is more preferable to be 8.5≦f3/f4×Z 13.3.

As described above, the present invention satisfying conditional expression (1) and conditional expression (2) reduces the moving distance of the lens groups constituting the optical system 100 in a reasonable range, and specifically, reduces the light beam height of a luminous flux that passes through the first lens group G1 and the fourth lens group G4. So, the diameters of lenses constituting the first lens group G1 and the fourth lens group G4 are reduced, and cost of glass material decreases with decreased amount of glass material. So, the present invention reduces cost of glass material and reduce the price of the zoom lens while maintaining high quality in imaging performance by constituting the optical system 100 by using a high refractive index glass material, instead of replacement of a glass material cheap and low in refractive index such as old material. Further, the downsizing of the optical system 100 is achieved because the diameter of the lenses constituting the first lens group G1 decreases and the entire optical length should be in a reasonable range.

### 2-2. Conditional Expression (3)

The present invention is preferable that the relationship between the moving distance (M2) of the second lens group G2 and the paraxial imaging magnification at the wide angle end and telephoto end of the fourth lens group G4 satisfies following conditional expression (3). Satisfaction of the following conditional expression (3) makes a lens barrel of the zoom lens compact because the ratio between the moving distance of the second lens group G2 and the zoom ratio of the fourth lens group G4 is optimized to result the reduced entire optical length within a reasonable range.

0.7≦M2/ft×(|βLT/βLw|)≦7.0 (3)

where,
M2: moving distance of the second lens group from wide angle end to telephoto end in magnification change
ft: focal length at telephoto end
β(beta)LW: paraxial imaging magnification at wide angle end of the fourth lens group
β(beta)LT: paraxial imaging magnification at telephoto end of the fourth lens group.

The value of “M2/ft×(|β(beta)LT/β(beta)Lw|)” exceeding the upper limit of conditional expression (3) is not preferable because the moving distance of the second lens group G2 increases or the zoom ratio of the fourth lens group G4 increases and makes the entire optical length long. The long entire optical length is not preferable because the diameter of the front lens increases and the optical system 100 is prolonged. Further, in the sum volume of all lenses constituting the optical system 100, the sum volume of the lenses constituting the first lens group G1 occupies about the half. So, increased diameters of the lenses constituting the first lens group G1 is not preferable because increased diameter is a big factor to increase cost of glass material. On the other hand, the value lower than the lower limit of conditional expression (3) is not preferable because the moving distance of the second lens group G2 decreases or the zoom ratio of the fourth lens group G4 decreases and make the entire optical length short. The short entire optical length is not preferable because maintaining of a high zoom ratio exceeding ten times is made difficult. To maintain higher quality in imaging performance, the value “M2/ft×(|β(beta)LT/β(3(beta)Lw|)” is more preferable to be 0.75<M2/ft×(|β(beta)LT/β(beta)Lw|)<6.8, and still more preferable to be 0.8<M2/ft×(|β(beta)LT/β(beta)Lw|)<6.5.

### 2-3. Conditional Expression (4)

The zoom lens according to the present invention is more preferable that the relationship between the moving distance (M1) of the first lens group G1 and the moving distance (M2) of the second lens group G2 satisfies following conditional expressions (4).

0.25≦|M2/M1|≦0.4 (4)

where,
M1: moving distance of the first lens group from wide angle end to telephoto end (where movement toward object side is “+”)
M2: moving distance of the second lens group from wide angle end to telephoto end (where movement toward object side is “+”).

Conditional expression (4) is an expression that specifies the ratio of the moving distances of the first lens group G1 and the second lens group G2 in magnification change from the wide angle end to the telephoto end. In the optical system 100 of the zoom lens in the present embodiment, the first lens group G1 and the second lens group G2 move toward the object side in magnification change from the wide angle end to the telephoto end. If the moving distance of the second lens group G2 is less than the moving distance of the first lens group G1 and in the range of conditional expression (4), the entire length of the lens barrel is made short because the moving distance of lens groups is adjusted in a preferable range with maintained high zoom ratio.

If the moving distance of the second lens group G2 exceeds the upper limit of conditional expression (4) and relatively increase than that of the moving distance of the first lens group G1, the entire optical length at the telephoto end increases. So, it is not preferable. On the other hand, if the value is lower than the lower limit of conditional expression (4) and the moving distance of the second lens group G2 relatively decreases than that of the moving distance of the first lens group G1, the moving distances of the third lens group G3 and the fourth lens group G4 should increase to maintain a high zoom ratio. If these lens groups move via a mechanism rotating a cam cylinder, the lens barrel enlarges because of complicated structure in the drive mechanism. So, it is not preferable.

To make the zoom lens smaller in size and maintain higher quality in imaging performance, the relationship between the moving distance (M1) of the first lens group G1 and the moving distance (M2) of the second lens group G2 is more preferable to satisfy 0.30≦|M2/M1|0.36, and still more preferable to satisfy 0.27≦|M2/M1|≦0.37.

The present invention will be specifically described with showing examples. Of course, the present invention is not limited to following Example 1 to Example 9. Example 1 to Example 9 show specific typical numerical values if the zoom lens according to the present invention is used in a digital SLR camera.

### EXAMPLE 1

The zoom lens in Example 1 will be described. The zoom lens in Example 1 has the lens structure similar to the optical system 100 (see FIG. 1). That is, the zoom lens in Example 1 includes the first lens group G1 having a positive refracting power, the second lens group G2 having a negative refracting power, the third lens group G3 having a positive refracting power and the fourth lens group G4 having a positive refracting power in order from the object side as the lens groups constituting the optical system 100. The second lens group G2 is a focusing lens group that moves in focusing as described above. Focusing from infinity to the close end of the object distance is performed by moving the second lens group G2 toward the object side. “STOP” shown in FIG. 1 is a stop. Further, “IMG” indicates an imaging surface.

In zooming from the wide angle end to the telephoto end, lens groups move along the optical axis backward and forward to change the gap between lens groups. The movement direction of lens groups and the gaps changes among the lens groups are schematically shown by arrows in FIG. 1.

The first lens group G1 (surface numbers 1 to 5) includes a cemented lens that cements the negative meniscus lens 11 having a convex surface at the object side and the positive biconvex lens 12, and the positive meniscus lens 13 having a convex surface at the object side in order from the object side. Note that, the surface numbers indicate numbers given to surfaces of the lenses constituting the optical system 100 in order from the object side. Note that, a cemented surface has one surface number.

The second lens group G2 (surface numbers 6 to 13) includes the negative meniscus lens 21 having a convex surface at the object side, the negative biconcave lens 22, the positive biconvex lens 23 and the negative meniscus lens 24 having a convex surface at the imaging side in order from the object side. In the second lens group G2, the negative biconcave lens 22 disposed second from the object side is a resin lens that is a both-surface aspherical lens whose both surfaces are aspherical surfaces.

The third lens group G3 (surface numbers 15 to 24) includes the lens group 3a (surface numbers 15 to 20) and the lens group 3b (surface numbers 21 to 24). The lens group 3a includes the positive biconvex lens 31, the positive biconvex lens 32 and the negative meniscus lens 33 in order from the object side. The lens group 3b (surface numbers 21 to 24) includes a cemented lens composed of the biconcave lens 34 and the positive meniscus lens 35. The aspherical surface layer 36 made of a resin material is bonded to the surface at the object side of the cemented lens. In Example 1, the lens group 3b moves in the direction perpendicular to the optical axis in vibration compensation. As for the moving distance of the lens group 3b in vibration compensation, if the correction angle is 0.3 deg., the moving distance of the lens group 3b in vibration compensation is 0.087 mm at the wide angle end, 0.182 mm at the middle focal length and 0.467 mm at the telephoto end.

The stop (STOP: surface number 14) is disposed between the second lens group G2 and the third lens group G3. The stop moves integrally with the third lens group G3.

The fourth lens group G4 (surface numbers 25 to 32) includes the positive meniscus lens 41 having a weak refracting power, the positive biconvex lens 42, the negative biconcave lens 43 and the positive biconvex lens 44 in order from the object side. The positive meniscus lens 41 disposed at the most object side is a resin lens, and is a both-surface aspherical lens whose both surfaces are aspherical surfaces.

Note that, the lens group 3a and the lens group 3b constituting the third lens group G3 in the zoom lens may independently move, and the gap between the lens group 3a and the lens group 3b may change in magnification change. If so, movement is preferable to make the gap between the lens group 3a and the lens group 3b narrow in magnification change from the wide angle end to the telephoto end to achieve high zoom ratio. Further, Example 1 disposed a resin lens in the second lens group and the fourth lens group may achieve further cost reduction.

Next, specific typical numerical values of lenses constituting the optical system 100 in Example 1 is shown in Table 1 to Table 3. Table 1 shows the surface data of lens surfaces. “No” is the surface number of a lens surface in Table 1. “R” is the curvature radius of the lens surface, and “D” is the gap to the next lens surface and indicates the lens thickness or the lens gap. “Nd” is the refractive index with respect to the d line, and “ABV” is the Abbe number. Further, ASPH indicates that the lens surface is an aspherical surface. Note that, these are the same in Table 4, Table 7, Table 10, Table 13, Table 16, Table 19, Table 22 and Table 25.

Table 2 shows data relating to the focal length (F), the F-number (Fno), the half image viewing angle (W) (deg.) and the lens gap (D(5), D(13), D(24) and D(32)) whose gap changes in magnification change. Data will be described in order, at the wide angle end, at the middle focal length and at the telephoto end. Note that, these are the same in Table 5, Table 8, Table 11, Table 14, Table 17, Table 20, Table 23 and Table 26.

Table 3 shows the aspherical surface data in lens surfaces. “No. ” is the surface number of the lens surface. Table 3 further shows conical coefficient K and aspherical surface coefficients A4, A6, A8 and A10 in each degree if the rotation-symmetric aspherical surface of lens surface is defined by the following expression. “E-a” indicates “×10^{-a}”. Note that, these are the same in Table 6, Table 9, Table 12, Table 15, Table 18, Table 21, Table 24 and Table 27.

x=cy2/[1+[1-(1+K)c2y2]1/2]+A4y4+A6y6+A8y8+A10y10 +A12y12 . . .

(where “c” is the curvature (1/R), “y” is the height from the optical axis, “K” is a conical coefficient, and “A4”, “A6”, “A8”, and so on, are the aspherical surface coefficients in respective degrees)

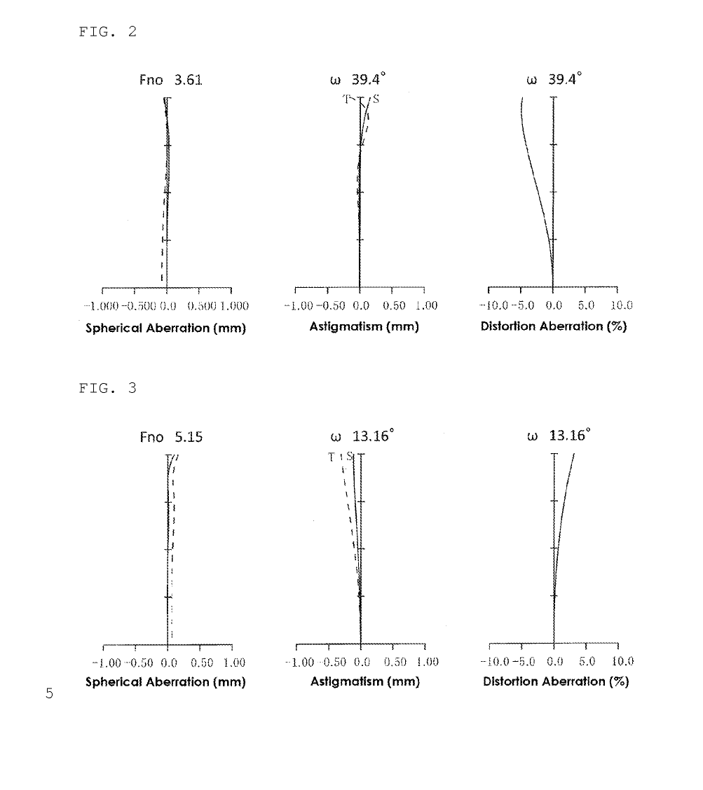

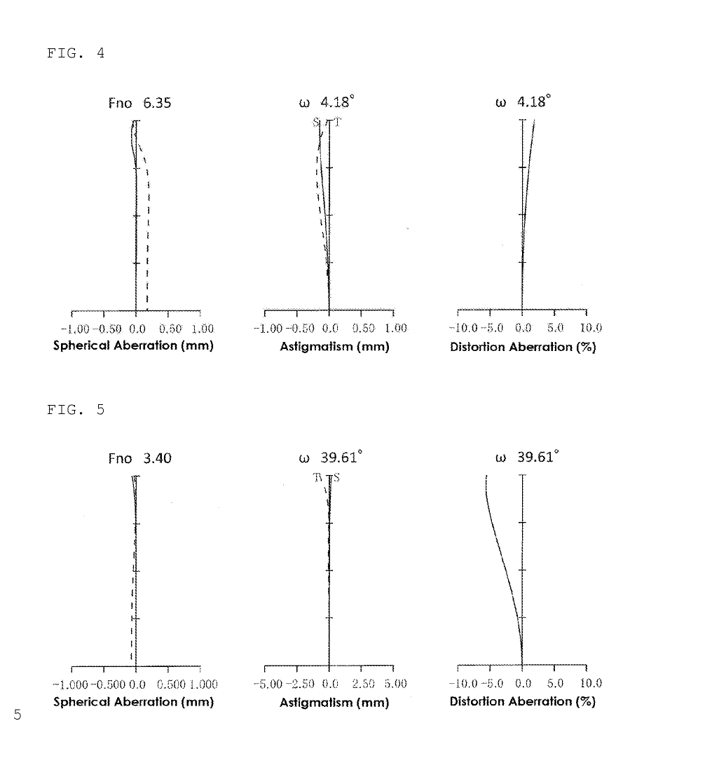

FIG. 1 is the lens structure at infinity focusing at the wide angle end, FIG. 2 is a longitudinal aberration diagram at the wide angle end, FIG. 3 is a longitudinal aberration diagram at the middle focal length, and FIG. 4 is a longitudinal aberration diagram at the telephoto end in Example 1. In the aberration diagrams, the solid line in the spherical aberration diagram indicates the d line and the broken line indicates the g line. In the astigmatism diagram, “S” is the sagittal direction and “T” is the tangential direction.

The distortion aberration diagram indicates a distortion aberration with the d line. Note that, these are the same in the following figures.

Conditional expression values are shown in Table 34. All of Examples including Example 1 satisfies the conditional expressions (1) to (4). FIG. 30 shows the conditional expression values.

TABLE 1

| No. | R | D | Nd | ABV |
|---|---|---|---|---|
| 1 | 79.2809 | 1.2000 | 1.84666 | 23.78 |
| 2 | 52.5933 | 6.6000 | 1.49700 | 81.61 |
| 3 | −614.1709 | 0.2000 | | |
| 4 | 51.3606 | 4.4000 | 1.51742 | 52.15 |
| 5 | 174.6119 | D (5) | | |
| 6 | 170.7500 | 1.1000 | 1.83481 | 42.72 |
| 7 | 12.7102 | 6.4500 | | |
| 8 ASPH | −29.7960 | 1.0000 | 1.53103 | 58.27 |
| 9 ASPH | 69.1204 | 0.2000 | | |
| 10 | 50.9813 | 4.2000 | 1.80518 | 25.46 |
| 11 | −23.0148 | 0.4500 | | |
| 12 | −19.4291 | 0.7000 | 1.77250 | 49.62 |
| 13 | −433.4039 | D (13) | | |
| 14 STOP | 0.0000 | 0.9000 | | |
| 15 | 30.2112 | 3.5000 | 1.48749 | 70.44 |
| 16 | −37.6753 | 2.5202 | | |
| 17 | 22.4251 | 3.2000 | 1.48749 | 70.44 |
| 18 | −111.3518 | 0.4700 | | |
| 19 | −46.0666 | 0.8000 | 1.84666 | 23.78 |
| 20 | −1662.1485 | 1.5101 | | |
| 21 ASPH | −45.6126 | 0.2000 | 1.51460 | 49.96 |
| 22 | −45.1441 | 0.7000 | 1.83400 | 37.34 |
| 23 | 17.4864 | 3.0000 | 1.80518 | 25.46 |
| 24 | 238.2673 | D (24) | | |
| 25 ASPH | 38.3664 | 1.2000 | 1.53103 | 58.27 |
| 26 ASPH | 43.8962 | 0.2088 | | |
| 27 | 35.4894 | 5.4000 | 1.51680 | 64.20 |
| 28 | −21.7154 | 0.2000 | | |
| 29 | −45.1186 | 0.8000 | 1.90366 | 31.31 |
| 30 | 27.7122 | 0.3300 | | |
| 31 | 32.9835 | 4.5000 | 1.61293 | 37.00 |
| 32 | −37.7350 | D (32) | | |

TABLE 2

| | | | |
|---|---|---|---|
| F | 18.5367 | 60.0953 | 194.9328 |
| Fno | 3.6102 | 5.1533 | 6.3504 |
| W | 39.3985 | 13.1639 | 4.1760 |
| D (5) | 1.5834 | 26.0201 | 47.9967 |
| D (13) | 27.0352 | 11.2267 | 1.8173 |
| D (24) | 8.0484 | 3.4417 | 1.7318 |
| D (32) | 43.6191 | 75.7442 | 97.0219 |

TABLE 3

| No. | K | A4 | A6 | A8 | A10 |
|---|---|---|---|---|---|
| 8 | 0.00000E+00 | −1.65721E−05 | 2.62792E−07 | −4.94483E−09 | 1.96956E−11 |
| 9 | 0.00000E+00 | −5.19679E−05 | 1.86714E−07 | −4.16967E−09 | 1.29125E−11 |
| 21 | 0.00000E+00 | 1.25827E−05 | −5.42177E−08 | 1.41785E−09 | −9.76635E−12 |
| 25 | 0.00000E+00 | 7.34439E−06 | −5.33421E−07 | −4.03799E−09 | 2.33281E−11 |
| 26 | 0.00000E+00 | 4.99364E−05 | −5.43708E−07 | −3.84796E−09 | 2.68169E−11 |

### EXAMPLE 2

Example 2 will be described. Since the optical system 100 of the zoom lens in Example 2 has the lens structure similar to Example 1, just difference from Example 1 will be described. In the optical system 100 in Example 2, among the lens group 3a and the lens group 3b constituting the third lens group 3G, the lens group 3b moves in the direction perpendicular to the optical axis in vibration compensation also. As for the moving distance of the lens group 3b in vibration compensation, if the correction angle is 0.3 deg., the moving distance of the lens group 3b in vibration compensation is 0.079 mm at the wide angle end, 0.159 mm at the middle focal length and 0.394 mm at the telephoto end. In Example 2, the lens group 3a and the lens group 3b may independently move along the optical axis direction in magnification change, and the movement direction is preferable to be similar in Example 1. The matter is the same in Example 3 and the other Examples.

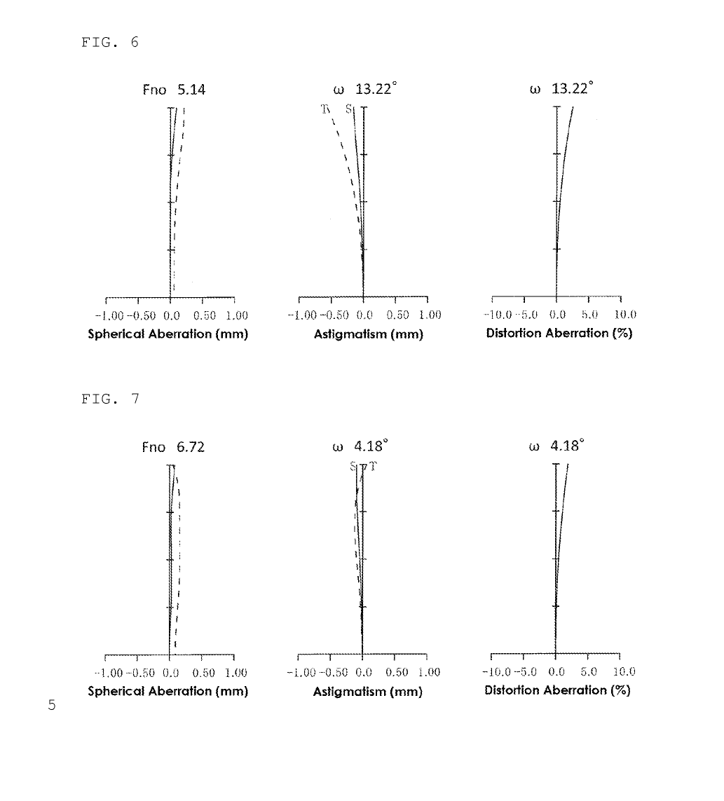

Table 4, Table 5 and Table 6 show the data including lens surface data, data on the focal length, and aspherical surface data of lenses constituting the optical system 100 of the zoom lens in Example 2. Conditional expression values are shown in FIG. 30. FIG. 5 shows a longitudinal aberration diagram at the wide angle end, FIG. 6 shows a longitudinal aberration diagram at the middle focal length, FIG. 7 shows a longitudinal aberration diagram at the telephoto end in Example 2.

TABLE 4

| No. | R | D | Nd | ABV |
|---|---|---|---|---|
| 1 | 85.6769 | 1.2000 | 1.84666 | 23.78 |
| 2 | 54.5491 | 6.6000 | 1.49700 | 81.61 |
| 3 | −744.1960 | 0.2000 | | |
| 4 | 51.0812 | 4.4000 | 1.51742 | 52.15 |
| 5 | 211.4159 | D (5) | | |
| 6 | 116.4863 | 1.1000 | 1.83481 | 42.72 |
| 7 | 12.9553 | 6.4500 | | |
| 8 ASPH | −30.6216 | 1.0000 | 1.53500 | 55.73 |
| 9 ASPH | 43.1756 | 0.2000 | | |
| 10 | 36.8962 | 4.2000 | 1.80518 | 25.46 |
| 11 | −24.1585 | 0.4500 | | |
| 12 | −18.9815 | 0.7000 | 1.77250 | 49.62 |
| 13 | −2518.8300 | D (13) | | |
| 14 STOP | 0.0000 | 0.9000 | | |
| 15 | 44.4322 | 3.5000 | 1.48749 | 70.44 |
| 16 | −27.9130 | 2.0548 | | |
| 17 | 24.4675 | 3.2000 | 1.48749 | 70.44 |
| 18 | −72.5666 | 0.6314 | | |
| 19 | −39.6143 | 0.8000 | 1.84666 | 23.78 |
| 20 | −254.6992 | 1.8960 | | |
| 21 ASPH | −42.9576 | 0.2000 | 1.51460 | 49.96 |
| 22 | −44.5492 | 0.7000 | 1.83400 | 37.34 |
| 23 | 16.8661 | 3.0000 | 1.80518 | 25.46 |
| 24 | 152.9125 | D (24) | | |
| 25 ASPH | 27.6365 | 2.0000 | 1.53500 | 55.73 |
| 26 ASPH | 36.8612 | 0.4000 | | |
| 27 | 33.0498 | 5.4000 | 1.51680 | 64.20 |
| 28 | −23.9442 | 0.2000 | | |
| 29 | −123.2342 | 0.8000 | 1.90366 | 31.31 |
| 30 | 21.0304 | 0.5096 | | |
| 31 | 24.4600 | 4.5000 | 1.61293 | 37.00 |
| 32 | −69.0950 | D (32) | | |

TABLE 5

| | | | |
|---|---|---|---|
| F | 18.5399 | 60.1820 | 194.9318 |
| Fno | 3.4035 | 5.1410 | 6.7162 |
| W | 39.6098 | 13.2190 | 4.1803 |
| D (5) | 1.5820 | 24.7478 | 47.5001 |
| D (13) | 25.1338 | 10.4459 | 1.8808 |
| D (24) | 9.8417 | 2.8601 | 1.2014 |
| D (32) | 43.2506 | 76.7171 | 101.2265 |

TABLE 6

| No. | K | A4 | A6 | A8 | A10 |
|---|---|---|---|---|---|
| 8 | 0.00000E+00 | −2.75012E−05 | 4.52637E−07 | −8.42515E−09 | 7.80026E−11 |
| 9 | 0.00000E+00 | −6.10468E−05 | 4.76965E−07 | −8.79289E−09 | 7.94088E−11 |
| 21 | 0.00000E+00 | 1.29035E−05 | −9.09540E−09 | 1.16929E−10 | −4.20437E−13 |
| 25 | 0.00000E+00 | 4.74367E−06 | −4.86981E−07 | −2.70490E−09 | 2.45037E−12 |
| 26 | 0.00000E+00 | 4.34690E−05 | −5.05282E−07 | −3.68874E−09 | 1.62240E−11 |

### EXAMPLE 3

Example 3 will be described. Since the optical system 100 of the zoom lens in Example 3 has the lens structure similar to Example 1, just difference from Example 1 will be described. In the optical system 100 in Example 3, among the lens group 3a and the lens group 3b constituting the third lens group 3G, the lens group 3b may moves in the direction perpendicular to the optical axis in vibration compensation. As for the moving distance of the lens group 3b in vibration compensation, if the correction angle is 0.3 deg., the moving distance of the lens group 3b in vibration compensation is 0.092 mm at the wide angle end, 0.190 mm at the middle focal length and 0.502 mm at the telephoto end.

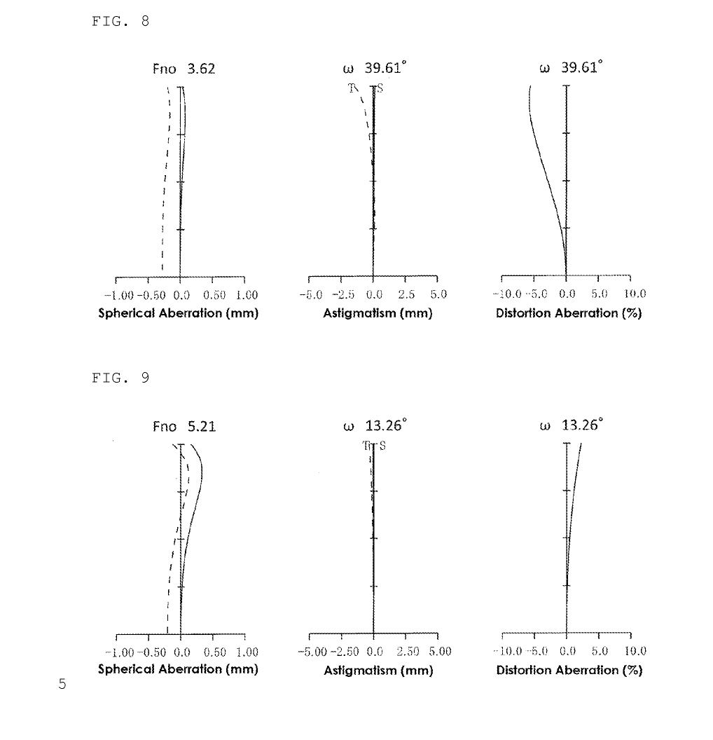

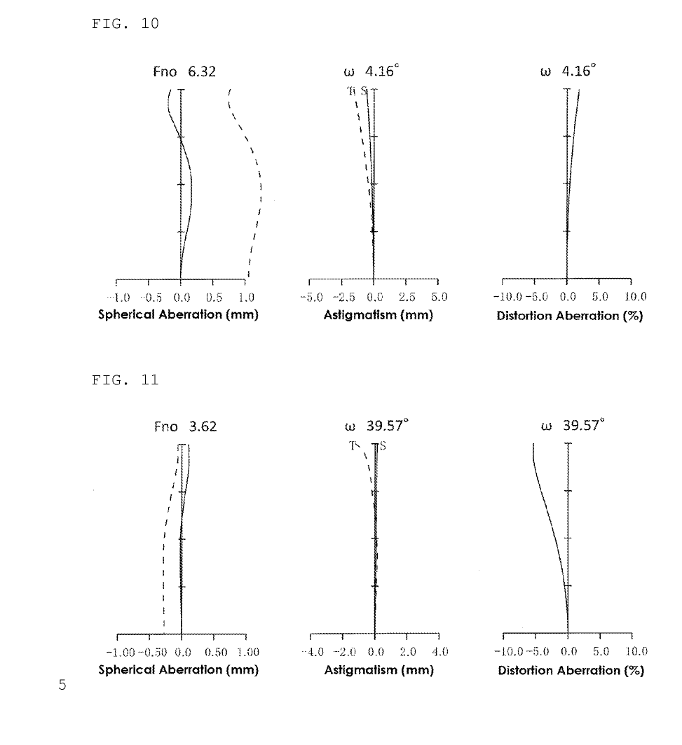

Table 7, Table 8 and Table 9 show the data including lens surface data, data on the focal length and aspherical surface data of lenses constituting the optical system 100 of the zoom lens in Example 3. FIG. 30 shows the conditional expression values. FIG. 8 shows a longitudinal aberration diagram at the wide angle end, FIG. 9 shows a longitudinal aberration diagram at the middle focal length and FIG. 10 shows a longitudinal aberration diagram at the telephoto end in Example 3.

TABLE 7

| No. | R | D | Nd | ABV |
|---|---|---|---|---|
| 1 | 91.1206 | 1.2000 | 1.84666 | 23.78 |
| 2 | 57.2364 | 6.6000 | 1.49700 | 81.61 |
| 3 | −523.7988 | 0.2000 | | |
| 4 | 48.3954 | 4.4000 | 1.51680 | 64.20 |
| 5 | 185.3256 | D (5) | | |
| 6 | 182.3140 | 1.1000 | 1.83481 | 42.72 |
| 7 | 13.2577 | 6.4500 | | |
| 8 ASPH | −27.0922 | 1.0000 | 1.53500 | 55.73 |
| 9 ASPH | 66.6091 | 0.2000 | | |
| 10 | 54.5997 | 4.2000 | 1.80518 | 25.46 |
| 11 | −22.6641 | 0.4500 | | |
| 12 | −18.7508 | 0.7000 | 1.77250 | 49.62 |
| 13 | −177.4878 | D (13) | | |
| 14 STOP | 0.0000 | 0.9000 | | |
| 15 | 32.1805 | 3.5000 | 1.51680 | 64.20 |
| 16 | −39.5557 | 1.9830 | | |
| 17 | 23.1885 | 3.2000 | 1.51680 | 64.20 |
| 18 | −143.2053 | 0.5000 | | |
| 19 | −54.9428 | 0.8000 | 1.84666 | 23.78 |
| 20 | 309.8476 | 2.0187 | | |
| 21 ASPH | −47.8349 | 0.2000 | 1.51460 | 49.96 |
| 22 | −46.6176 | 0.7000 | 1.83400 | 37.34 |
| 23 | 17.8362 | 3.0000 | 1.80518 | 25.46 |
| 24 | 290.6415 | D(24) | | |
| 25 ASPH | 75.3409 | 1.2000 | 1.53500 | 55.73 |
| 26 ASPH | 94.4836 | 0.4000 | | |
| 27 | 41.3810 | 5.4000 | 1.51680 | 64.20 |
| 28 | −19.8912 | 0.2000 | | |
| 29 | −35.9150 | 0.8000 | 1.90366 | 31.31 |
| 30 | 31.4438 | 0.3000 | | |
| 31 | 35.6142 | 4.5000 | 1.61293 | 37.00 |
| 32 | −34.4792 | D (32) | | |

TABLE 8

| | | | |
|---|---|---|---|
| F | 18.5400 | 60.1660 | 195.4995 |
| Fno | 3.6232 | 5.2074 | 6.3201 |
| W | 39.6091 | 13.2567 | 4.1630 |
| D (5) | 1.5697 | 25.0141 | 47.5122 |
| D (13) | 27.7471 | 11.3069 | 1.8493 |
| D (24) | 8.1860 | 2.7275 | 1.2023 |
| D (32) | 43.3957 | 77.2303 | 98.9073 |

TABLE 9

| No. | K | A4 | A6 | A8 | A10 |
|---|---|---|---|---|---|
| 8 | 0.00000E+00 | −1.67051E−05 | 3.95191E−07 | −4.45115E−09 | 3.38256E−11 |
| 9 | 0.00000E+00 | −4.46961E−05 | 1.55973E−07 | −2.68929E−09 | 2.63524E−11 |
| 21 | 0.00000E+00 | 1.08594E−05 | −1.14466E−08 | 4.21678E−10 | −3.44129E−12 |
| 25 | 0.00000E+00 | 8.92273E−06 | −4.95377E−07 | −3.38730E−09 | 3.17411E−11 |
| 26 | 0.00000E+00 | 5.32950E−05 | −4.34238E−07 | −3.30968E−09 | 3.14940E−11 |

### EXAMPLE 4

Example 4 will be described. Since the optical system 100 of the zoom lens in Example 4 has the lens structure similar to Example 1, just difference from Example 1 will be described. In the optical system 100 in Example 4, among the lens group 3a and the lens group 3b constituting the third lens group 3G, the lens group 3b may moves in the direction perpendicular to the optical axis in vibration compensation. As for the moving distance of the lens group 3b in vibration compensation, if the angle correction is 0.3 deg., the moving distance of the lens group 3b in vibration compensation is 0.099 mm at the wide angle end, 0.195 mm at the middle focal length and 0.505 mm at the telephoto end.

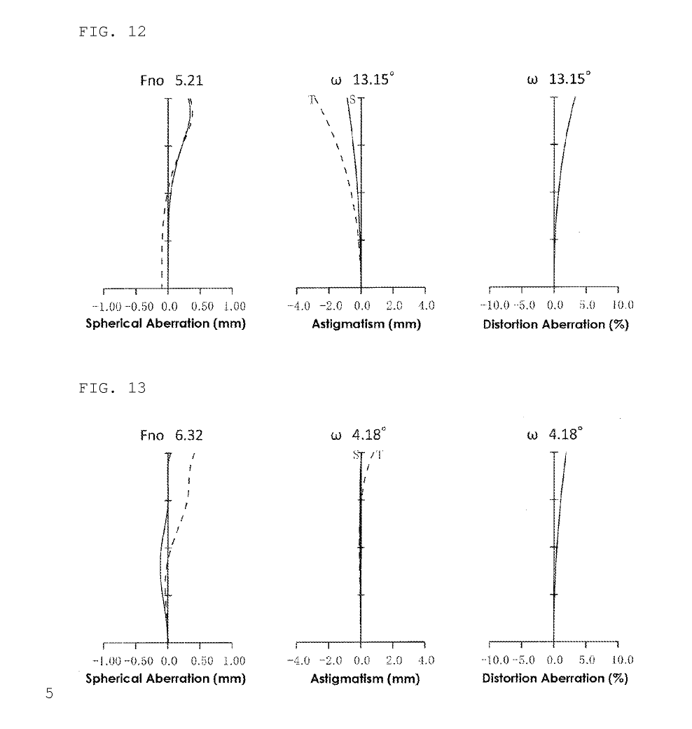

Table 10, Table 11 and Table 12 show the data including lens surface data, data on the focal length and aspherical surface data of lenses constituting the optical system 100 of the zoom lens in Example 4. FIG. 30 shows conditional expression values. FIG. 11 shows a longitudinal aberration diagram at the wide angle end, FIG. 12 shows a longitudinal aberration diagram at the middle focal length and FIG. 13 shows a longitudinal aberration diagram at the telephoto end in Example 4.

TABLE 10

| No. | R | D | Nd | ABV |
|---|---|---|---|---|
| 1 | 72.9234 | 1.2000 | 1.84666 | 23.78 |
| 2 | 46.4791 | 6.6000 | 1.48749 | 70.44 |
| 3 | −417.8784 | 0.2000 | | |
| 4 | 70.9880 | 4.4000 | 1.59551 | 39.22 |
| 5 | 278.6753 | D (5) | | |
| 6 | 278.6753 | 1.1000 | 1.83481 | 42.72 |
| 7 | 14.6372 | 6.4500 | | |
| 8 ASPH | −26.5101 | 1.0000 | 1.53500 | 55.73 |
| 9 ASPH | 48.1439 | 0.2000 | | |
| 10 | 61.7992 | 4.2000 | 1.80518 | 25.46 |
| 11 | −24.3665 | 0.4500 | | |
| 12 | −21.3765 | 0.7000 | 1.77250 | 49.62 |
| 13 | −175.3295 | D (13) | | |
| 14 STOP | 0.0000 | 0.9000 | | |
| 15 | 32.6012 | 3.5000 | 1.51823 | 58.96 |
| 16 | −35.1785 | 0.1500 | | |
| 17 | 26.4069 | 3.2000 | 1.51823 | 58.96 |
| 18 | −106.0549 | 0.5000 | | |
| 19 | −46.9670 | 0.8000 | 1.84666 | 23.78 |
| 20 | 1187.1848 | 3.8505 | | |
| 21 ASPH | −47.3498 | 0.2000 | 1.51460 | 49.96 |
| 22 | −45.9055 | 0.7000 | 1.83400 | 37.34 |
| 23 | 21.4907 | 3.0000 | 1.80518 | 25.46 |
| 24 | 451.5217 | D (24) | | |
| 25 ASPH | 37.0000 | 1.2000 | 1.53500 | 55.73 |
| 26 ASPH | 40.7491 | 0.4000 | | |
| 27 | 39.6153 | 5.4000 | 1.51680 | 64.20 |
| 28 | −20.6521 | 0.2000 | | |
| 29 | −44.2668 | 0.8000 | 1.90366 | 31.31 |
| 30 | 27.7632 | 0.3000 | | |
| 31 | 29.2040 | 4.5000 | 1.61293 | 37.00 |
| 32 | −44.4225 | D (32) | | |

TABLE 11

| | | | |
|---|---|---|---|
| F | 18.5400 | 60.0650 | 194.9318 |
| Fno | 3.6232 | 5.2074 | 6.3201 |
| W | 39.5658 | 13.1537 | 4.1751 |
| D (5) | 1.5456 | 23.7125 | 49.9865 |
| D (13) | 27.3287 | 10.2295 | 1.8827 |
| D (24) | 11.4139 | 3.3853 | 1.2000 |
| D (32) | 40.6110 | 78.6522 | 99.8302 |

TABLE 12

| No. | K | A4 | A6 | A8 | A10 |
|---|---|---|---|---|---|
| 8 | 0.00000E+00 | −7.03354E−06 | −4.42659E−07 | 2.74935E−09 | 4.43087E−12 |
| 9 | 0.00000E+00 | −4.08021E−05 | −2.80851E−07 | 1.61432E−09 | 1.22777E−11 |
| 21 | 0.00000E+00 | 1.74968E−05 | −3.50285E−07 | 4.36919E−09 | −1.76130E−11 |
| 25 | 0.00000E+00 | −1.36106E−05 | −1.70783E−07 | −6.08880E−09 | 2.59240E−11 |
| 26 | 0.00000E+00 | 3.63745E−05 | −3.85643E−07 | −3.57530E−09 | 2.04368E−11 |

### EXAMPLE 5

Example 5 will be described. Since the optical system 100 of the zoom lens in Example 5 has the lens structure similar to Example 1, just difference from Example 1 will be described. In the optical system 100 in Example 5, among the lens group 3a and the lens group 3b constituting the third lens group 3G, the lens group 3b may moves in the direction perpendicular to the optical axis in vibration compensation. As for the moving distance of the lens group 3b in vibration compensation, if the correction angle is 0.3 deg., the moving distance of the lens group 3b in vibration compensation is 0.091 mm at the wide angle end, 0.190 mm at the middle focal length and 0.490 mm at the telephoto end.

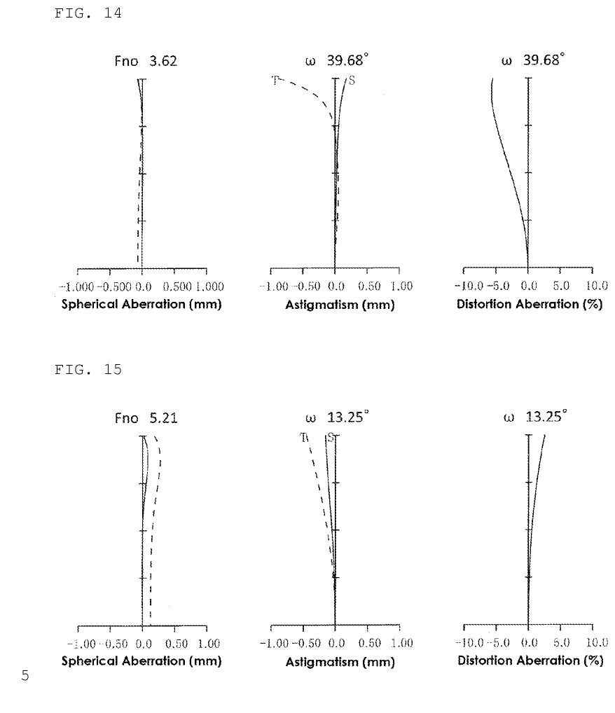

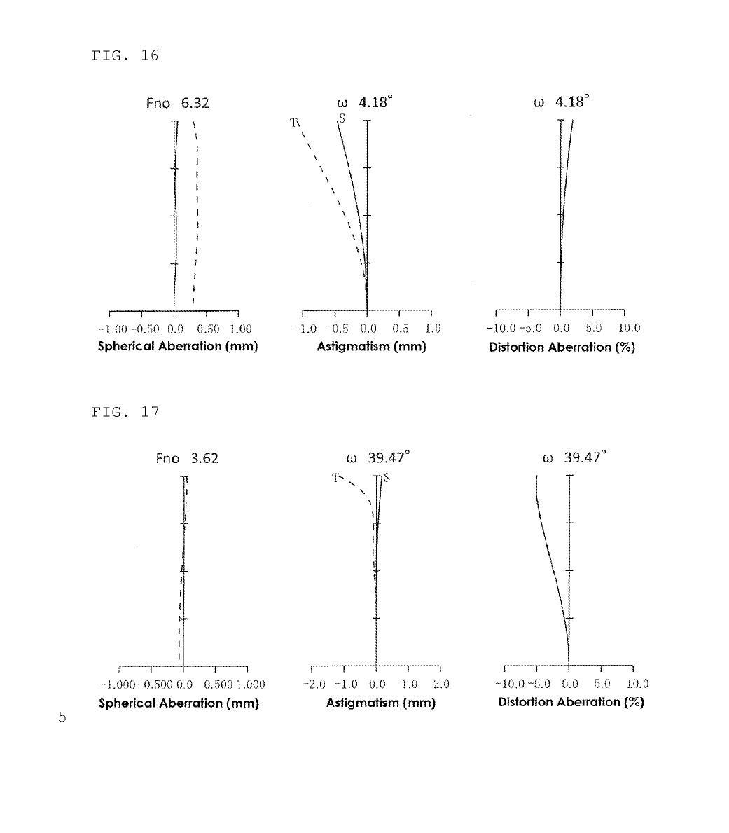

Table 13, Table 14 and Table 15 show the data including lens surface data, data on the focal length and aspherical surface data of lenses constituting the optical system 100 of the zoom lens in Example 5. FIG. 30 shows conditional expression values. Furthermore, FIG. 14 shows a longitudinal aberration diagram at the wide angle end, FIG. 15 shows a longitudinal aberration diagram at the middle focal length and FIG. 16 shows the longitudinal aberration diagram at the telephoto end in Example 5.

TABLE 13

| No. | R | D | Nd | ABV |
|---|---|---|---|---|
| 1 | 87.9705 | 1.2000 | 1.84666 | 23.78 |
| 2 | 55.9570 | 6.6000 | 1.49700 | 81.61 |
| 3 | −533.1265 | 0.2000 | | |
| 4 | 49.2072 | 4.4000 | 1.51742 | 52.15 |
| 5 | 184.2358 | D(5) | | |
| 6 | 184.2358 | 1.1000 | 1.83481 | 42.72 |
| 7 | 13.0892 | 6.4500 | | |
| 8 ASPH | −27.8354 | 1.0000 | 1.53500 | 55.73 |
| 9 ASPH | 67.0009 | 0.2000 | | |
| 10 | 54.5278 | 4.2000 | 1.80518 | 25.46 |
| 11 | −22.2269 | 0.4500 | | |
| 12 | −18.6218 | 0.7000 | 1.77250 | 49.62 |
| 13 | −198.3548 | D(13) | | |
| 14 STOP | 0.0000 | 0.9000 | | |
| 15 | 30.9646 | 3.5000 | 1.48749 | 70.44 |
| 16 | −37.5699 | 2.3135 | | |
| 17 | 21.6821 | 3.2000 | 1.48749 | 70.44 |
| 18 | −126.7672 | 0.5000 | | |
| 19 | −52.5246 | 0.8000 | 1.84666 | 23.78 |
| 20 | 411.5239 | 1.7340 | | |
| 21 ASPH | −47.1034 | 0.2000 | 1.51460 | 49.96 |
| 22 | −45.9074 | 0.7000 | 1.83400 | 37.34 |
| 23 | 17.5206 | 3.0000 | 1.80518 | 25.46 |
| 24 | 317.2560 | D(24) | | |
| 25 ASPH | 51.1486 | 1.2000 | 1.53500 | 55.73 |
| 26 ASPH | 59.0630 | 0.4000 | | |
| 27 | 39.8261 | 5.4000 | 1.51680 | 64.20 |
| 28 | −20.2459 | 0.2000 | | |
| 29 | −36.9099 | 0.8000 | 1.90366 | 31.31 |
| 30 | 30.8406 | 0.3000 | | |
| 31 | 36.0487 | 4.5000 | 1.61293 | 37.00 |
| 32 | −34.1339 | D(32) | | |

TABLE 14

| | | | |
|---|---|---|---|
| F | 18.4949 | 60.0388 | 194.9318 |
| Fno | 3.6232 | 5.2074 | 6.3201 |
| W | 39.6763 | 13.2503 | 4.1751 |
| D(5) | 1.5895 | 25.1165 | 47.5336 |
| D(13) | 27.6924 | 11.2968 | 1.8533 |
| D(24) | 7.8637 | 2.7234 | 1.2388 |
| D(32) | 43.5044 | 77.2024 | 99.0680 |

TABLE 15

| No. | K | A4 | A6 | A8 | A10 |
|---|---|---|---|---|---|
| 8 | 0.00000E+00 | −1.72244E−05 | 3.19998E−07 | −4.18778E−09 | 2.60950E−11 |
| 9 | 0.00000E+00 | −4.86493E−05 | 1.86883E−07 | −3.10856E−09 | 1.71030E−11 |
| 21 | 0.00000E+00 | 1.07417E−05 | −3.93349E−09 | 2.04714E−10 | −1.18387E−12 |
| 25 | 0.00000E+00 | 8.56737E−06 | −5.00019E−07 | −3.59691E−09 | 2.50071E−11 |
| 26 | 0.00000E+00 | 5.30171E−05 | −4.59615E−07 | −3.69832E−09 | 2.80634E−11 |

### EXAMPLE 6

Example 6 will be described. Since the optical system 100 of the zoom lens in Example 6 has the lens structure similar to Example 1, just difference from Example 1 will be described. In the optical system 100 in Example 6, among the lens group 3a and the lens group 3b constituting the third lens group 3G, the lens group 3b may moves in the direction perpendicular to the optical axis in vibration compensation. As for the moving distance of the lens group 3b in vibration compensation, if the correction angle is 0.3 deg., the moving distance of the lens group 3b in vibration compensation is 0.093 mm at the wide angle end, 0.190 mm at the middle focal length and 0.503 mm at the telephoto end.

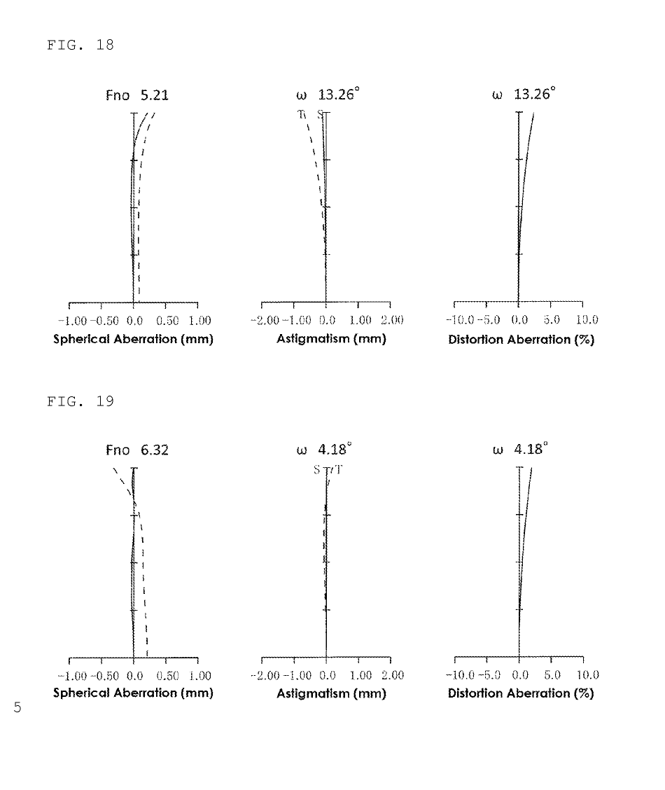

Table 16, Table 17 and Table 18 show the data including lens surface data, data on the focal length, and aspherical surface data of lenses constituting the optical system 100 of the zoom lens in Example 6. FIG. 30 shows conditional expression values. FIG. 17 shows a longitudinal aberration diagram at the wide angle end, FIG. 18 shows a longitudinal aberration diagram at the middle focal length and FIG. 19 shows a longitudinal aberration diagram at the telephoto end in Example 6.

TABLE 16

| No. | R | D | Nd | ABV |
|---|---|---|---|---|
| 1 | 80.1795 | 1.2000 | 1.84666 | 23.78 |
| 2 | 52.5830 | 6.6000 | 1.49700 | 81.61 |
| 3 | −1499.5977 | 0.2000 | | |
| 4 | 48.7939 | 4.4000 | 1.51742 | 52.15 |
| 5 | 182.4637 | D(5) | | |
| 6 | 127.7312 | 1.1000 | 1.83481 | 42.72 |
| 7 | 11.4033 | 6.4500 | | |
| 8 ASPH | −22.1263 | 1.0000 | 1.53500 | 55.73 |
| 9 ASPH | −170.8187 | 0.2000 | | |
| 10 | 64.2619 | 4.2000 | 1.80518 | 25.46 |
| 11 | −21.2327 | 0.4500 | | |
| 12 | −17.4462 | 0.7000 | 1.77250 | 49.62 |
| 13 | −153.0147 | D(13) | | |
| 14 STOP | 0.0000 | 0.9000 | | |
| 15 | 32.5759 | 3.5000 | 1.48749 | 70.44 |
| 16 | −28.1520 | 1.6769 | | |
| 17 | 26.5013 | 3.2000 | 1.48749 | 70.44 |
| 18 | −110.0391 | 0.8000 | | |
| 19 | −29.8141 | 0.8000 | 1.84666 | 23.78 |
| 20 | −84.1143 | 2.1667 | | |
| 21 ASPH | −48.5225 | 0.2000 | 1.51460 | 49.96 |
| 22 | −47.1299 | 0.7000 | 1.83400 | 37.34 |
| 23 | 18.0639 | 3.0000 | 1.80518 | 25.46 |
| 24 | 292.4861 | D(24) | | |
| 25 ASPH | 68.8155 | 1.2000 | 1.53500 | 55.73 |
| 26 ASPH | 77.8852 | 0.4000 | | |
| 27 | 42.6551 | 5.6000 | 1.51680 | 64.20 |
| 28 | −19.2945 | 0.2000 | | |
| 29 | −38.8321 | 0.8000 | 1.90366 | 31.31 |
| 30 | 29.2522 | 0.3000 | | |
| 31 | 34.4536 | 4.5000 | 1.61293 | 37.00 |
| 32 | −35.4954 | D(32) | | |

TABLE 17

| | | | |
|---|---|---|---|
| F | 18.5400 | 60.0868 | 194.9318 |
| Fno | 3.6232 | 5.2074 | 6.3201 |
| W | 39.4719 | 13.2649 | 4.1752 |
| D(5) | 1.6639 | 25.2764 | 48.3682 |
| D(13) | 26.7932 | 11.0434 | 1.8023 |
| D(24) | 8.4816 | 1.7184 | 1.3072 |
| D(32) | 43.4589 | 77.6727 | 97.8548 |

TABLE 18

| No. | K | A4 | A6 | A8 | A10 |
|---|---|---|---|---|---|
| 8 | 0.00000E+00 | 2.45035E−05 | −6.52477E−08 | −9.02104E−09 | 3.86589E−11 |
| 9 | 0.00000E+00 | −2.63639E−05 | −2.98791E−07 | −6.77767E−09 | 2.49265E−11 |
| 21 | 0.00000E+00 | 1.11942E−05 | −2.16091E−08 | 5.76059E−10 | −3.65561E−12 |
| 25 | 0.00000E+00 | 3.49150E−05 | −4.55109E−07 | −5.45488E−09 | 2.51667E−11 |
| 26 | 0.00000E+00 | 7.39117E−05 | −4.05991E−07 | −5.74949E−09 | 3.15973E−11 |

### EXAMPLE 7

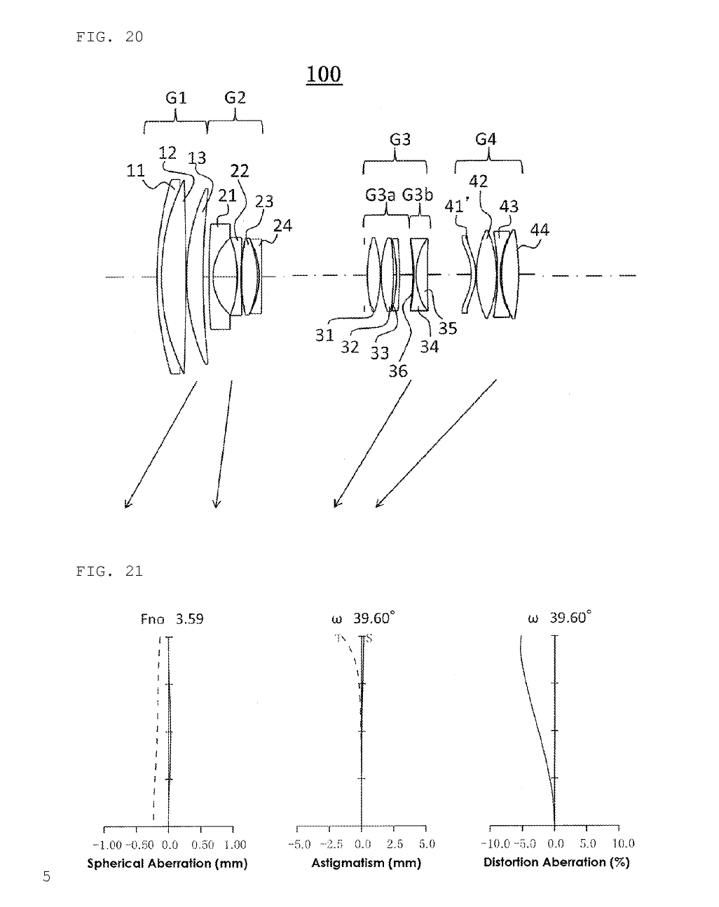

Example 7 will be described. As shown in FIG. 20, the optical system 100 of the zoom lens in Example 7 has the lens structure similar to Example 1 except that a meniscus lens having a convex surface at the imaging side and weak in refracting power is disposed at the most object side of the fourth lens group. FIG. 20 shows the lens structure at infinity focusing at the wide angle end in Example 7.

In the optical system 100 in Example 7, among the lens group 3a and the lens group 3b constituting the third lens group 3G, the lens group 3b may moves in the direction perpendicular to the optical axis in vibration compensation. As for the moving distance of the lens group 3b in vibration compensation, if the correction angle is 0.3 deg., the moving distance of the lens group 3b in vibration compensation is 0.097 mm at the wide angle end, 0.199 mm at the middle focal length and 0.527 mm at the telephoto end.

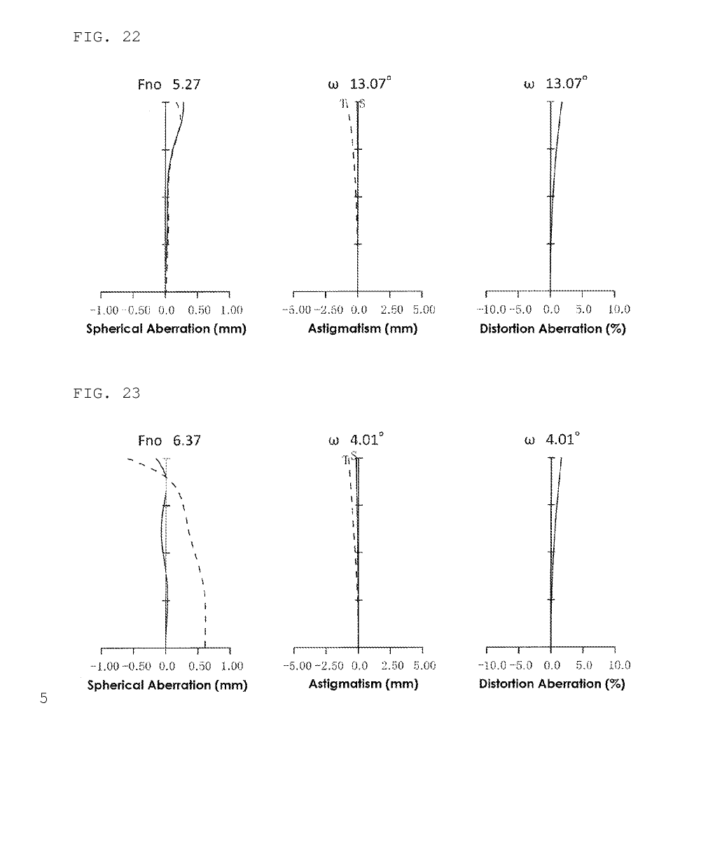

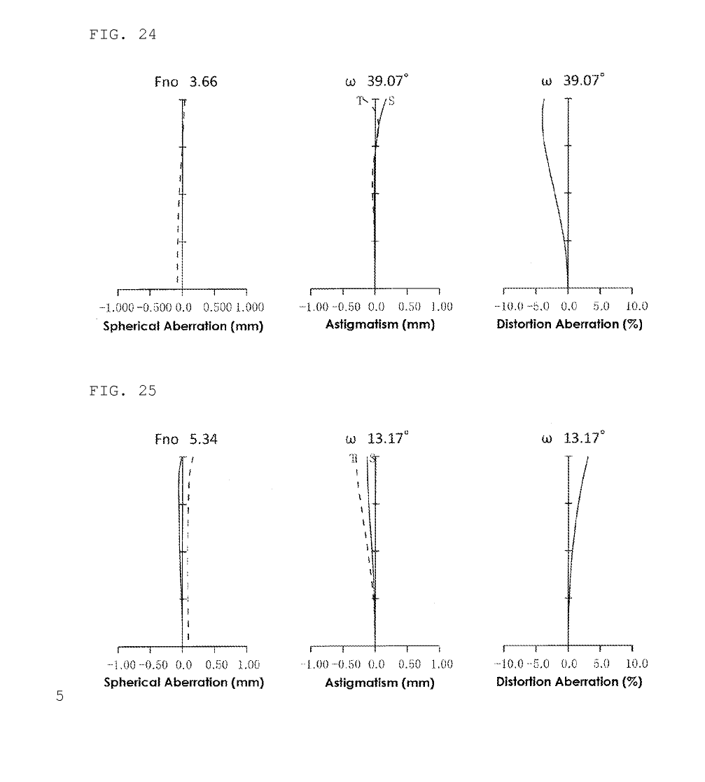

Table 19, Table 20 and Table 21 show the data including lens surface data, data on the focal length, and aspherical surface data of lenses constituting the optical system 100 of the zoom lens in Example 7. FIG. 30 shows conditional expression values. FIG. 21 shows a longitudinal aberration diagram at the wide angle end in Example 7, FIG. 22 shows a longitudinal aberration diagram at the middle focal length and FIG. 23 shows a longitudinal aberration diagram at the telephoto end.

TABLE 19

| No. | R | D | Nd | ABV |
|---|---|---|---|---|
| 1 | 71.4962 | 1.2000 | 1.84666 | 23.78 |
| 2 | 52.4147 | 6.6000 | 1.49700 | 81.61 |
| 3 | −1013.6274 | 0.2000 | | |
| 4 | 47.6080 | 4.4000 | 1.48749 | 70.44 |
| 5 | 123.2328 | D(5) | | |
| 6 | 123.2328 | 1.1000 | 1.83481 | 42.72 |
| 7 | 11.6811 | 6.4500 | | |
| 8 ASPH | −27.9166 | 1.0000 | 1.53500 | 55.73 |
| 9 ASPH | 131.4249 | 0.2000 | | |
| 10 | 43.3973 | 4.2000 | 1.80518 | 25.46 |
| 11 | −25.9831 | 0.4500 | | |
| 12 | −20.0342 | 0.7000 | 1.77250 | 49.62 |
| 13 | −869.5093 | D(13) | | |
| 14 STOP | 0.0000 | 0.9000 | | |
| 15 | 34.6110 | 3.5000 | 1.48749 | 70.44 |
| 16 | −28.3188 | 0.1500 | | |
| 17 | 26.4520 | 3.2000 | 1.48749 | 70.44 |
| 18 | −93.7009 | 0.9544 | | |
| 19 | −33.4025 | 0.8000 | 1.84666 | 23.78 |
| 20 | −106.3347 | 3.5632 | | |
| 21 ASPH | −54.1355 | 0.2000 | 1.51460 | 49.96 |
| 22 | −52.9865 | 0.7000 | 1.83400 | 37.34 |
| 23 | 15.8564 | 3.0000 | 1.80518 | 25.46 |
| 24 | 207.9317 | D(24) | | |
| 25 ASPH | −12.6347 | 1.2000 | 1.53500 | 55.73 |
| 26 ASPH | −12.6347 | 0.2000 | | |
| 27 | 25.4697 | 5.4000 | 1.51680 | 64.20 |
| 28 | −26.2247 | 0.2000 | | |
| 29 | −58.7955 | 0.8000 | 1.90366 | 31.31 |
| 30 | 20.9729 | 0.3528 | | |
| 31 | 22.8004 | 4.5000 | 1.61293 | 37.00 |
| 32 | −68.3416 | D(32) | | |

TABLE 20

| | | | |
|---|---|---|---|
| F | 18.4858 | 61.3464 | 203.5256 |
| Fno | 3.5898 | 5.2679 | 6.3744 |
| W | 39.5953 | 13.0725 | 4.0102 |
| D(5) | 1.5266 | 24.4540 | 47.5012 |
| D(13) | 27.1193 | 10.8459 | 1.8000 |
| D(24) | 11.7337 | 4.3824 | 3.6598 |
| D(32) | 40.0000 | 76.8247 | 99.2955 |

TABLE 21

| No. | K | A4 | A6 | A8 | A10 |
|---|---|---|---|---|---|
| 8 | 0.00000E+00 | −1.03854E−05 | 5.66810E−07 | −1.14827E−08 | 5.49264E−11 |
| 9 | 0.00000E+00 | 4.91347E−05 | 3.30323E−07 | −8.92544E−09 | 3.68810E−11 |
| 21 | 0.00000E+00 | 8.99346E−06 | 4.71578E−08 | −9.52737E−11 | −2.95358E−12 |
| 25 | 0.00000E+00 | 4.60791E−06 | 2.31200E−06 | 7.62364E−09 | −6.03724E−11 |
| 26 | 0.00000E+00 | 3.54700E−05 | 1.93673E−06 | 8.41548E−09 | −4.31780E−11 |

### EXAMPLE 8

Example 8 will be described. Since the optical system 100 of the zoom lens in Example 8 has the lens structure similar to Example 1, just difference from Example 1 will be described. In the optical system 100 in Example 8, the lens group 3a and the lens group 3b constituting the third lens group independently move along the optical axis direction to make the air space between the lens group 3a and the lens group 3b narrow in magnification change. In the optical system 100, among the lens group 3a and the lens group 3b constituting the third lens group 3G, the lens group 3b may moves in the direction perpendicular to the optical axis in vibration compensation. As for the moving distance of the lens group 3b in vibration compensation, if the correction angle is 0.3 deg., the moving distance of the lens group 3b in vibration compensation is 0.089 mm at the wide angle end, 0.181 mm at the middle focal length and 0.474 mm at the telephoto end.

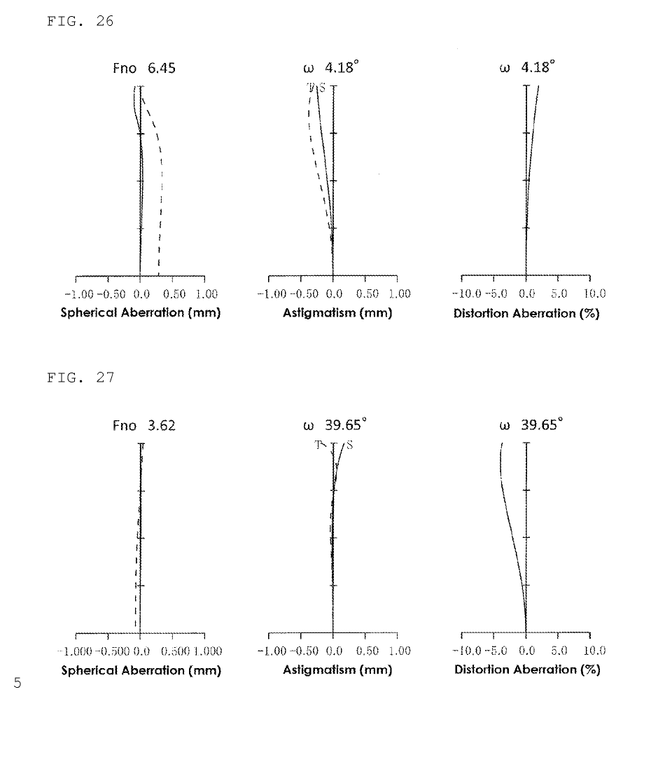

Table 22, Table 23 and Table 24 show the data including lens surface data, data on the focal length, and aspherical surface data of lenses constituting the optical system 100 of the zoom lens in Example 8. FIG. 30 shows conditional expression values. FIG. 24 shows a longitudinal aberration diagram at the wide angle end in Example 8, FIG. 25 shows a longitudinal aberration diagram at the middle focal length and FIG. 26 shows a longitudinal aberration diagram at the telephoto end.

TABLE 22

| No. | R | D | Nd | ABV |
|---|---|---|---|---|
| 1 | 78.7433 | 1.2000 | 1.84666 | 23.78 |
| 2 | 52.6992 | 6.7000 | 1.49700 | 81.61 |
| 3 | −667.7771 | 0.2000 | | |
| 4 | 52.6948 | 4.4000 | 1.51742 | 52.15 |
| 5 | 176.8095 | D(5) | | |
| 6 | 171.4263 | 1.2000 | 1.83481 | 42.72 |
| 7 | 12.4677 | 6.3809 | | |
| 8 ASPH | −30.1202 | 1.0000 | 1.53110 | 58.60 |
| 9 ASPH | 74.4645 | 0.2000 | | |
| 10 | 50.1721 | 4.4000 | 1.80518 | 25.46 |
| 11 | −23.5391 | 0.4600 | | |
| 12 | −19.6638 | 0.7000 | 1.77250 | 49.62 |
| 13 | −268.9056 | D(13) | | |
| 14 STOP | 0.0000 | 0.9000 | | |
| 15 | 29.3794 | 3.6000 | 1.48749 | 70.44 |
| 16 | −37.4302 | 1.6270 | | |
| 17 | 23.8446 | 3.7000 | 1.48749 | 70.44 |
| 18 | −89.4371 | 0.4000 | | |
| 19 | −42.6556 | 0.8000 | 1.84666 | 23.78 |
| 20 | −512.7271 | D(20) | | |
| 21 ASPH | −46.7691 | 0.2000 | 1.51460 | 49.96 |
| 22 | −46.9730 | 0.8000 | 1.83400 | 37.34 |
| 23 | 17.0833 | 3.1000 | 1.80518 | 25.46 |
| 24 | 212.5403 | D(24) | | |
| 25 ASPH | 48.5158 | 1.2000 | 1.53110 | 58.60 |
| 26 ASPH | 58.0346 | 0.1500 | | |
| 27 | 33.7204 | 5.6000 | 1.51680 | 64.20 |
| 28 | −22.3278 | 0.1560 | | |
| 29 | −46.1490 | 0.8000 | 1.90366 | 31.31 |
| 30 | 26.2451 | 0.3800 | | |
| 31 | 31.8064 | 4.5000 | 1.61293 | 37.00 |
| 32 | −37.8637 | D(32) | | |

TABLE 23

| | | | |
|---|---|---|---|
| F | 18.5400 | 60.1100 | 194.9329 |
| Fno | 3.6649 | 5.3376 | 6.4466 |
| W | 39.0745 | 13.1688 | 4.1752 |
| D(5) | 1.5138 | 25.1995 | 48.8656 |
| D(13) | 27.6423 | 11.1430 | 1.8088 |
| D(20) | 2.7248 | 2.5603 | 1.7730 |
| D(24) | 7.8979 | 2.8172 | 1.3800 |
| D(32) | 41.4174 | 75.4358 | 95.4506 |

TABLE 24

| No. | K | A4 | A6 | A8 | A10 |
|---|---|---|---|---|---|
| 8 | 0.00000E+00 | −1.14769E−05 | 4.70839E−08 | −2.63504E−09 | 1.24054E−11 |
| 9 | 0.00000E+00 | −4.98347E−05 | −4.49970E−08 | −1.88618E−09 | 6.45086E−12 |
| 21 | 0.00000E+00 | 1.19796E−05 | −2.92430E−08 | 9.47719E−10 | −7.32654E−12 |
| 25 | 0.00000E+00 | −1.07090E−05 | −4.72810E−07 | −2.76695E−09 | 2.07109E−11 |
| 26 | 0.00000E+00 | 2.99368E−05 | −4.59231E−07 | −2.41715E−09 | 2.15679E−11 |

### EXAMPLE 9

Example 9 will be described. Since the optical system 100 of the zoom lens in Example 9 has the lens structure similar to Example 1, just difference from Example 1 will be described. In the optical system 100 in Example 9, the lens group 3a and the lens group 3b constituting the third lens group independently move along the optical axis direction to make the air space between the lens group 3a and the lens group 3b narrow in magnification change. In the optical system 100, among the lens group 3a and the lens group 3b constituting the third lens group 3G, the lens group 3b may moves in the direction perpendicular to the optical axis in vibration compensation. As for the moving distance of the lens group 3b in vibration compensation, if the correction angle is 0.3 deg., the moving distance of the lens group 3b in vibration compensation is 0.089 mm at the wide angle end, 0.181 mm at the middle focal length and 0.474 mm at the telephoto end.

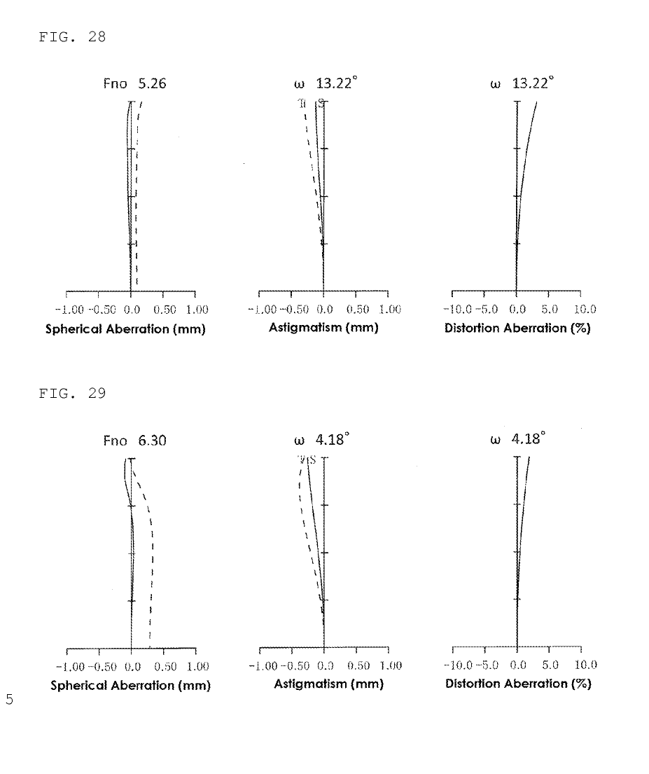

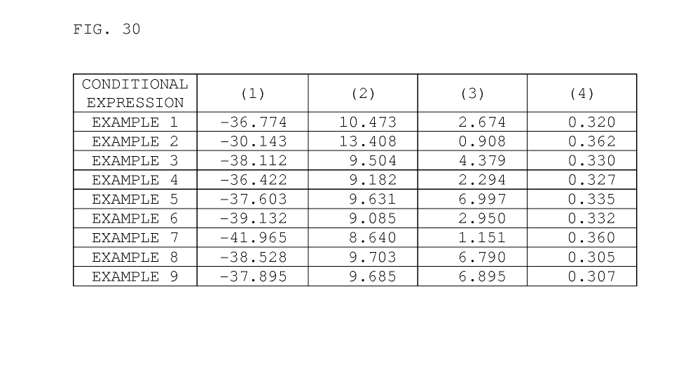

Table 25, Table 26 and Table 27 show the data including lens surface data, data on the focal length, and aspherical surface data of lenses constituting the optical system 100 of the zoom lens in Example 9. FIG. 30 shows conditional expression values. FIG. 27 shows a longitudinal aberration diagram at the wide angle end, FIG. 28 shows a longitudinal aberration diagram at the middle focal length and FIG. 29 shows a longitudinal aberration diagram at the telephoto end in Example 9.

TABLE 25

| No. | R | D | Nd | ABV |
|---|---|---|---|---|
| 1 | 81.0662 | 1.2000 | 1.84666 | 23.78 |
| 2 | 53.5297 | 6.6000 | 1.49700 | 81.61 |
| 3 | −814.2792 | 0.2000 | | |
| 4 | 52.2329 | 4.4000 | 1.51742 | 52.15 |
| 5 | 195.9920 | D(5) | | |
| 6 | 195.9920 | 1.1000 | 1.83481 | 42.72 |
| 7 | 12.8669 | 6.4500 | | |
| 8 ASPH | −26.6048 | 1.0000 | 1.53103 | 58.27 |
| 9 ASPH | 98.2891 | 0.2000 | | |
| 10 | 50.8434 | 4.4000 | 1.80518 | 25.46 |
| 11 | −23.3493 | 0.4600 | | |
| 12 | −19.0740 | 0.7000 | 1.77250 | 49.62 |
| 13 | −230.6555 | D(13) | | |
| 14 STOP | 0.0000 | 0.9000 | | |
| 15 | 32.4971 | 3.6000 | 1.48749 | 70.44 |
| 16 | −34.7066 | 1.9500 | | |
| 17 | 23.1922 | 3.6000 | 1.48749 | 70.44 |
| 18 | −89.2603 | 0.4500 | | |
| 19 | −42.0273 | 0.8000 | 1.84666 | 23.78 |
| 20 | −467.3151 | D(20) | | |
| 21 ASPH | −47.8795 | 0.2000 | 1.51460 | 49.96 |
| 22 | −48.3845 | 0.7000 | 1.83400 | 37.34 |
| 23 | 16.8825 | 3.0000 | 1.80518 | 25.46 |
| 24 | 194.2614 | D(24) | | |
| 25 ASPH | 34.3111 | 1.2000 | 1.53103 | 58.27 |
| 26 ASPH | 37.7297 | 0.1500 | | |
| 27 | 37.0491 | 5.6000 | 1.51680 | 64.20 |
| 28 | −20.7740 | 0.1600 | | |
| 29 | −37.6215 | 0.8000 | 1.90366 | 31.31 |
| 30 | 29.7997 | 0.3800 | | |
| 31 | 35.8567 | 4.5000 | 1.61293 | 37.00 |
| 32 | −32.7692 | D(32) | | |

TABLE 26

| | | | |
|---|---|---|---|
| F | 18.5136 | 60.0681 | 194.9318 |
| Fno | 3.6223 | 5.2626 | 6.2969 |
| W | 39.6510 | 13.2226 | 4.1751 |
| D(5) | 1.5962 | 25.3923 | 48.9184 |
| D(13) | 27.6928 | 11.2082 | 1.8013 |
| D(20) | 2.8381 | 2.4372 | 1.6000 |
| D(24) | 8.0972 | 2.3333 | 1.2000 |
| D(32) | 41.9921 | 76.3615 | 96.9967 |

TABLE 27

| No. | K | A4 | A6 | A8 | A10 |
|---|---|---|---|---|---|
| 8 | 0.00000E+00 | 1.31599E−05 | −2.73202E−08 | −3.40841E−09 | 2.47387E−11 |
| 9 | 0.00000E+00 | −2.32801E−05 | −1.87538E−07 | −1.36401E−09 | 8.45448E−12 |
| 21 | 0.00000E+00 | 1.24302E−05 | −5.08935E−08 | 1.07027E−09 | −6.51853E−12 |
| 25 | 0.00000E+00 | 1.70166E−05 | −6.84744E−07 | −3.95111E−09 | 2.71942E−11 |
| 26 | 0.00000E+00 | 6.02044E−05 | −7.15308E−07 | −3.74756E−09 | 3.10070E−11 |

### SYMBOL LIST

11 Negative lens having convex surface at object side

12 Positive lens

13 Positive lens having convex surface at object side

21 Negative lens (negative meniscus lens disposed at most object side)

22 Negative lens (negative lens disposed next to negative meniscus lens)

31 Positive biconvex lens

32 Positive biconvex lens

33 Negative lens having concave surface at object side

100 Optical system

G1 First lens group

G2 Second lens group

G3 Third lens group

G3a Lens group 3a

G3b Lens group 3b

G4 Fourth lens group

1. A zoom lens, comprising:
at least the first lens group having a positive refracting power, the second lens group having a negative refracting power, the third lens group having a positive refracting power and the fourth lens group having a positive refracting power as the lens groups constituting an optical system in order from an object side; and
a predetermined zoom ratio is achieved by moving all lens groups constituting the optical system along an optical axis direction to adjust gaps, wherein:
the first lens group includes a negative lens having a convex surface at the object side, a positive lens and a positive lens having a convex surface at the object side in order from the object side;
the second lens group includes at least two negative lenses and one positive lens;
the third lens group includes two positive biconvex lenses adjacently disposed, and a negative lens having a concave surface at the object side in order from the object side; and
the zoom lens satisfies following conditional expression (1) and conditional expression (2):
-42≦f123t/f4×Z≦-25 (1)
8.2≦f3/f4×Z≦13.6 (2)
where,
f123t: synthetic focal length at telephoto end of the first lens group to the third lens group
f3: focal length of the third lens group
f4: focal length of the fourth lens group
Z: zoom ratio (focal length at telephoto end/focal length at wide angle end).

2. The zoom lens according to claim 1, wherein a curvature radius of a surface at the object side of a positive biconvex lens second from the object side in the two positive biconvex lenses adjacently disposed in the third lens group is smaller than a curvature radius of the surface at an imaging side.

3. The zoom lens according to claim 1, wherein the zoom lens satisfies following conditional expression (3):
0.7≦M2/ft×(|βLT/βLw|)≦7.0 (₃)
where,
M2: moving distance of the second lens group from wide angle end to telephoto end in magnification change
ft: focal length at telephoto end
β(beta)LW: paraxial imaging magnification at wide angle end of the fourth lens group
β(beta)LT: paraxial imaging magnification at telephoto end of the fourth lens group.

4. The zoom lens according to claim 1, that satisfies following conditional expression (4):
0.25≦|M2/M1|≦0.4 (4)
where,
M1: moving distance of the first lens group from wide angle end to telephoto end (where movement toward object side is “+”)
M2: moving distance of the second lens group from wide angle end to telephoto end (where movement toward object side is “+”).

5. The zoom lens according to claim 1, wherein the lens groups move to make the gap between the first lens group and the second lens group wide, the gap between the second lens group and the third lens group narrow and the gap between the third lens group and the fourth lens group narrow in magnification change from a wide angle end to a telephoto end.

6. The zoom lens according to claim 1, wherein the lens groups constituting the optical system further include the fifth lens group following the fourth lens group in addition to the first lens group to the fourth lens group, wherein
the lens groups move to make the gap between the first lens group and the second lens group wide, the gap between the second lens group and the third lens group narrow, the gap between the third lens group and the fourth lens group narrow and the gap between the fourth lens group and the fifth lens group wide in magnification change from a wide angle end to a telephoto end.

7. The zoom lens according to claim 1, wherein:
the third lens group includes the lens group 3a having a positive refracting power and the lens group 3b having a negative refracting power; and
the lens group 3b moves in a direction perpendicular to an optical axis in vibration compensation.

8. The zoom lens according to claim 1, wherein the third lens group includes the lens group 3a having a positive refracting power and the lens group 3b having a negative refracting power, the lens groups move to make the gap between the first lens group and the second lens group wide, the gap between the second lens group and the lens group 3a narrow, the gap between the lens group 3a and the lens group 3b wide and the gap between the lens group 3b and the fourth lens group narrow in magnification change from a wide angle end to a telephoto end.

9. The zoom lens according to claim 8, wherein the lens group 3b moves in a direction perpendicular to an optical axis in vibration compensation.

10. The zoom lens according to claim 1, wherein the lens groups constituting the optical system further include a fixed lens or a fixed lens group at the most imaging side in addition to the first lens group to the fourth lens group.

11. The zoom lens according to claim 1, wherein the second lens group moves toward the object side in focusing from infinity to close end of an object distance.

12. The zoom lens according to claim 1, wherein the second lens group and/or the fourth lens group include at least one lens made of resin.

13. The zoom lens according to claim 2, wherein the zoom lens satisfies following conditional expression (3):
0.7≦M2/t×(|LT/βLw|)≦7.0 (3)
where,
M2: moving distance of the second lens group from wide angle end to telephoto end in magnification change
ft: focal length at telephoto end
β(beta)LW: paraxial imaging magnification at wide angle end of the fourth lens group
β(beta)LT: paraxial imaging magnification at telephoto end of the fourth lens group.

14. The zoom lens according to claim 2, that satisfies following conditional expression (4):
0.25≦|M2/M1|≦0.4 (4)
where,
M1: moving distance of the first lens group from wide angle end to telephoto end (where movement toward object side is “+”)
M2: moving distance of the second lens group from wide angle end to telephoto end (where movement toward object side is “+”).

15. The zoom lens according to claim 3, that satisfies following conditional expression (4):
0.25≦|M2/M1|≦0.4 (4)
where,
M1: moving distance of the first lens group from wide angle end to telephoto end (where movement toward object side is “+”)
M2: moving distance of the second lens group from wide angle end to telephoto end (where movement toward object side is “+”).

16. The zoom lens according to claim 2, wherein the lens groups move to make the gap between the first lens group and the second lens group wide, the gap between the second lens group and the third lens group narrow and the gap between the third lens group and the fourth lens group narrow in magnification change from a wide angle end to a telephoto end.

17. The zoom lens according to claim 3, wherein the lens groups move to make the gap between the first lens group and the second lens group wide, the gap between the second lens group and the third lens group narrow and the gap between the third lens group and the fourth lens group narrow in magnification change from a wide angle end to a telephoto end.

18. The zoom lens according to claim 4, wherein the lens groups move to make the gap between the first lens group and the second lens group wide, the gap between the second lens group and the third lens group narrow and the gap between the third lens group and the fourth lens group narrow in magnification change from a wide angle end to a telephoto end.

19. The zoom lens according to claim 2, wherein the lens groups constituting the optical system further include the fifth lens group following the fourth lens group in addition to the first lens group to the fourth lens group, wherein
the lens groups move to make the gap between the first lens group and the second lens group wide, the gap between the second lens group and the third lens group narrow, the gap between the third lens group and the fourth lens group narrow and the gap between the fourth lens group and the fifth lens group wide in magnification change from a wide angle end to a telephoto end.

20. The zoom lens according to claim 3, wherein the lens groups constituting the optical system further include the fifth lens group following the fourth lens group in addition to the first lens group to the fourth lens group, wherein
the lens groups move to make the gap between the first lens group and the second lens group wide, the gap between the second lens group and the third lens group narrow, the gap between the third lens group and the fourth lens group narrow and the gap between the fourth lens group and the fifth lens group wide in magnification change from a wide angle end to a telephoto end.
